(19) United States
(12) Patent Application Publication
(10) Pub. No.: US 2010/0306716 A1
(43) Pub. Date: Dec. 2, 2010

(54) EXTENDING STANDARD GESTURES

(75) Inventor: Kathryn Stone Perez, Shoreline, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/475,295

(22) Filed: May 29, 2009

(51) Int. Cl. G06F 3/033

(52) U.S. Cl. 715/863

(57) ABSTRACT

In a system that utilizes gestures for controlling aspects of an application, strict requirements for success may limit approachability or accessibility for different types of people. The system may receive data reflecting movement of a user and remap a standard gesture to correspond to the received data. Following the remapping, the system may receive data reflecting skeletal movement of a user, and determine from that data whether the user has performed one or more standard and/or remapped gestures. In an exemplary embodiment, a gesture library comprises a plurality of gestures. Where these gestures are complementary with each other, they may be grouped into gesture packages. A gesture package may include gestures that are packaged as remapped gestures or a gesture package may include options for remapping standard gestures to new data.

### BACKGROUND

Many computing applications such as computer games, multimedia applications, office applications or the like use controls to allow users to manipulate game characters or other aspects of an application. Typically such controls are input using, for example, controllers, remotes, keyboards, mice, or the like. Unfortunately, such controls can be difficult to learn, thus creating a barrier between a user and such games and applications. Furthermore, such controls may be different than actual game actions or other application actions for which the controls are used. For example, a game control that causes a game character to swing a baseball bat may not correspond to an actual motion of swinging the baseball bat.

### SUMMARY

Game applications tend to have a single failure or success metric, where very specific controls must occur for success in the game. In a system that uses handheld controllers, the user may quickly learn to manipulate the inputs on a controller, such as pushing a particular button or a combination of buttons. Even systems that monitor the movement of the controller are typically easy to learn because the motion required to manipulate the controller can be minimized to simple hand control.

Described herein are systems and methods employed such that a user may perform gestures in the physical space, where the gestures are translated to a control in a system or application space, such as a virtual space and/or a game space. In a system that utilizes gestures for controlling aspects of an application, strict requirements for success may limit approachability or accessibility for different types of people. For example, consider a user with a broken leg who has limited mobility or use of a limb trying to perform a gesture that comprises lower body motion, such as a jump or kick.

Packages of standard gestures are gestures from which system and application developers can incorporate gesture recognition into their systems and/or applications. Disclosed herein are systems and methods for remapping a standard gesture. For example, a system may receive data reflecting skeletal movement of a user and remap a standard gesture to correspond to the received data. Following the remapping, the system may receive data reflecting skeletal movement of a user, and determine from that data whether the user has performed one or more standard and/or remapped gestures.

In an exemplary embodiment, a gesture library comprises a plurality of gestures. Where these gestures are complementary with each other, they may be grouped into gesture packages. These gesture packages are then provided to applications for use by a gesture recognizer engine, in both gaming contexts and non-gaming contexts. An application may utilize one or more gesture packages. A gesture package may include gestures that are packaged as remapped gestures or a gesture package may include options for remapping standard gestures to new data. Thus, the remapped gesture may be provided with the gesture package or the user may have the option to remap a standard gesture. An application may assign a value to a first parameter of a standard or remapped gesture. The recognizer engine sets the first parameter with the value, and can also set or remap the value of any other parameters of that gesture or any other gestures in the gesture package that are dependent upon the value of the first gesture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for a gesture recognizer system architecture in accordance with this specification are further described with reference to the accompanying drawings in which:

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system and incorporate chaining and animation blending techniques.

FIG. 3 illustrates an example embodiment of a computing environment in which the animation techniques described herein may be embodied.

FIG. 4 illustrates another example embodiment of a computing environment in which the animation techniques described herein may be embodied.

FIG. 5A illustrates a skeletal mapping of a user that has been generated from a depth image.

FIG. 5B illustrates further details of the gesture recognizer architecture shown in FIG. 2.

FIG. 6 depicts an example target recognition, analysis, and tracking system and an example display of a user performing a gesture in the physical space.

FIGS. 7A-7E depict example snapshots of a user's motion in a physical space for performing gestures in a skiing game application.

FIGS. 8A-8E depict example snapshots of a user's motion in a physical space for remapping gestures in a skiing game application.

FIGS. 9A-9E illustrates a skeletal mapping of the user that has been generated from a depth image captured from the user's motion shown in FIGS. 8A-8E.

FIG. 10 illustrate an example structure for gestures, gesture packages, and genre packages, including remapped gestures.

FIG. 11 depicts an example flow diagram for a method remapping gestures.

### DETAILED DESCRIPTION OF ILLUSTRATIVE EMBODIMENTS

As will be described herein, a user may control an application executing on a computing environment, such as a game console, a computer, or the like, by performing one or more gestures. According to one embodiment, the data representative of a gesture, such as depth image of a scene, may be received by, for example, a capture device. In one embodiment, the capture device or computing system coupled to the capture device may determine whether one or more targets or objects in the scene corresponds to a human target such as the user. To determine whether a target or object in the scene corresponds a human target, each of the targets may be flood filled and compared to a pattern of a human body model. Each target or object that matches the human body model may then be scanned to generate a skeletal model associated therewith. For example, a target identified as a human may be scanned to generate a skeletal model associated therewith. The skeletal model may then be provided to the computing environment for tracking the skeletal model and rendering an avatar associated with the skeletal model.

Captured motion may be any motion in the physical space that is captured by the capture device, such as a camera. The captured motion could include the motion of a target in the physical space, such as a user or an object. The user's motions and/or gestures may be mapped to a visual representation of the user. The motion may be dynamic, such as a running motion, or the motion may be static, such as a user that is posed with little movement. The captured motion may include a gesture that translates to a control in an operating system or application. Thus, a user's motions may be tracked, modeled, and displayed, and the user's gestures recognized from the motion may control certain aspects of an operating system or executing application. Similar principles apply to objects or other non-human targets in the physical space. The system may receive image data and capture motion with respect to any target in the scene and translate the received data for visually representing the target and/or recognizing gestures from the captured motion.

A gesture recognizer engine, the architecture of which is described more fully below, may be used to determine when a particular gesture has been made by a target, such as a user. A gesture package may include standard gestures, gestures that are packaged as remapped gestures, or gestures having an option to remap the gesture. Thus, remapped gestures may be provided with the gesture package or the system or a user may be given the ability to remap a standard gesture. The computing environment may determine which controls to perform in an application executing on the computer environment that correspond to the remapped gestures based on, for example, the gestures of the user that have been recognized and mapped to the skeletal model. A visual representation of the user may be displayed, such as via an avatar on a screen, that maps to the user's motions, and the user control aspects of the application by gesturing in the physical space.

Disclosed herein are techniques for remapping a gesture such that a different motion or motion(s) correspond(s) to the recognition of a particular gesture. Each gesture applicable to a system or application may correspond to the recognition of particular motions in the physical space. As is disclosed herein, sometimes it is desirable to remap the motion that corresponds to the recognition of a particular gesture. For example, consider a person with a physical disability, such as the inability to walk or motion with the user's legs. Gestures that are recognized based on motion of a user's legs could prevent the user from successfully controlling those aspects of the application. For example, consider the execution of a soccer game application that comprises a package of gestures applicable to game. If a gesture comprises the user making a kicking motion in the physical space, a disabled person may have difficulty performing this motion. In another example, a young child may not be capable of performing a gesture that requires a complex motion or a motion that is defined with respect to a taller user. Techniques for remapping a different motion(s) to a particular gesture may enable users who otherwise would fail to perform the requisite motion for a gesture to instead successfully perform a motion that is recognized as the particular gesture. The gesture recognizer engine, for example, may recognize when a particular gesture has been made by the user based on the parameters of the remapped gesture.

The system, methods, and components of remapping gestures described herein may be embodied in a multi-media console, such as a gaming console, or in any other computing device in which it is desired to utilize gestures to control aspects of the environment, including, by way of example and without any intended limitation, satellite receivers, set top boxes, arcade games, personal computers (PCs), portable telephones, personal digital assistants (PDAs), and other hand-held devices.

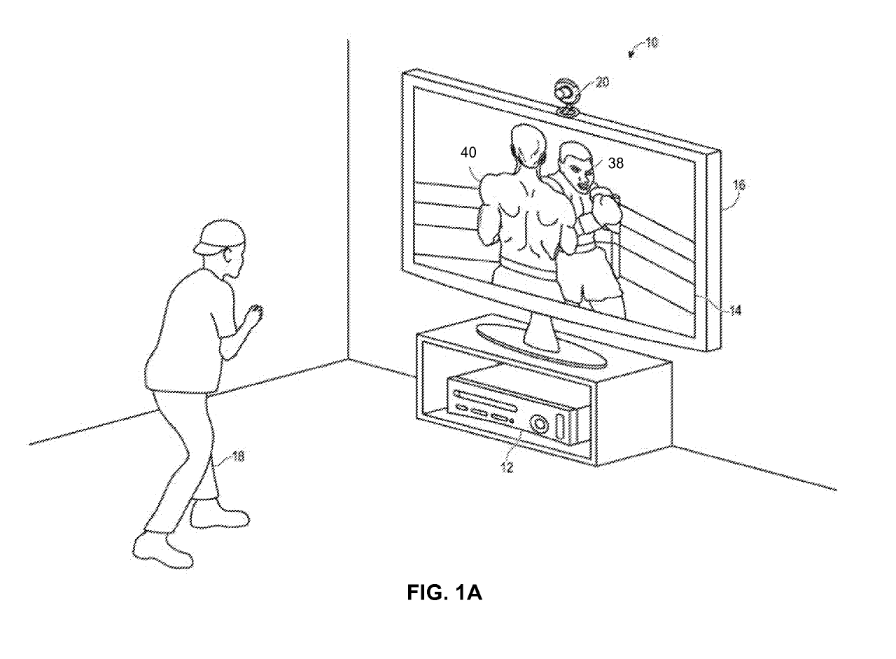

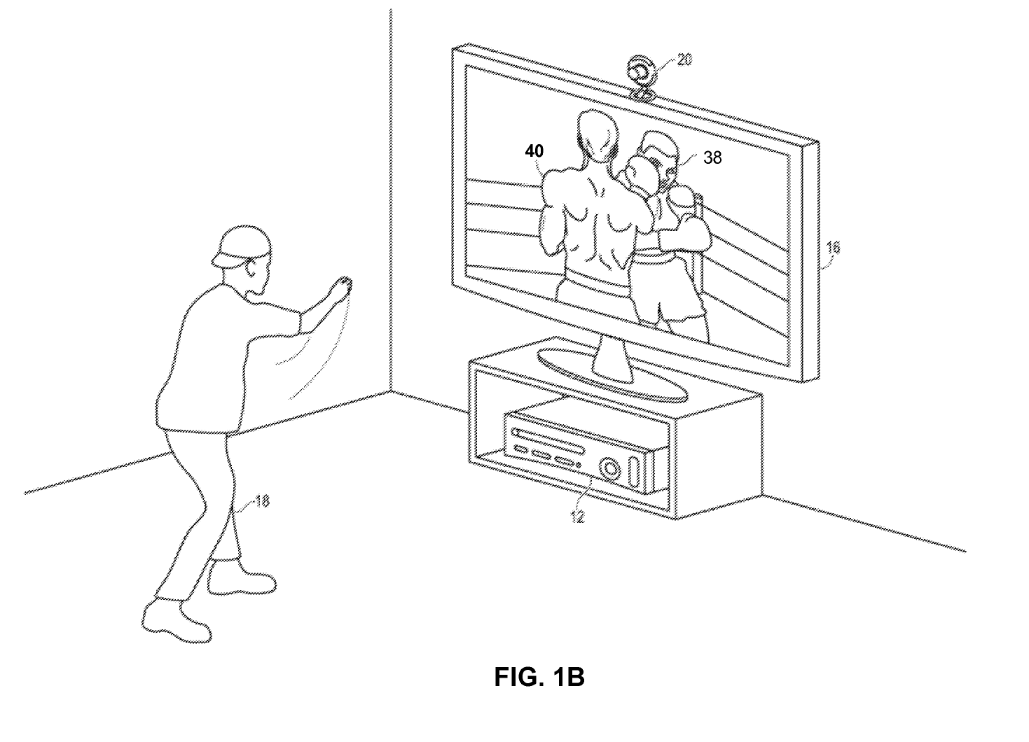

FIGS. 1A and 1B illustrate an example embodiment of a configuration of a target recognition, analysis, and tracking system 10 that may employ techniques for remapping a gesture. In the example embodiment, a user 18 playing a boxing game. In an example embodiment, the system 10 may recognize, analyze, and/or track a human target such as the user 18. The system 10 may gather information related to the user's gestures in the physical space.

As shown in FIG. 1A, the target recognition, analysis, and tracking system 10 may include a computing environment 12. The computing environment 12 may be a computer, a gaming system or console, or the like. According to an example embodiment, the computing environment 12 may include hardware components and/or software components such that the computing environment 12 may be used to execute applications such as gaming applications, non-gaming applications, or the like.

As shown in FIG. 1A, the target recognition, analysis, and tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions within an application, as will be described in more detail below.

According to one embodiment, the target recognition, analysis, and tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the target recognition, analysis, and tracking system 10 may be used to recognize, analyze, and/or track a human target such as the user 18. For example, the user 18 may be tracked using the capture device 20 such that the movements of user 18 may be interpreted as controls that may be used to affect the application being executed by computer environment 12. Thus, according to one embodiment, the user 18 may move his or her body to control the application. In another example embodiment, the user 18 may move his or her body for remapping a gesture to the user's motion.

The system 10 may translate an input to a capture device 20 into an animation, the input being representative of a user's motion, such that the animation is driven by that input. Thus, the user's motions may map to an avatar 40 such that the user's motions in the physical space are performed by the avatar 40. The user's motions may be gestures that are applicable to a control in an application. As shown in FIGS. 1A and 1B, in an example embodiment, the application executing on the computing environment 12 may be a boxing game that the user 18 may be playing, where the user's actions translate to controls in the boxing game, such as a punch.

The computing environment 12 may use the audiovisual device 16 to provide a visual representation of a player avatar 40 that the user 18 may control with his or her movements. For example, as shown in FIG. 1B, the user 18 may throw a punch in physical space to cause the player avatar 40 to throw a punch in game space. The player avatar 40 may have the characteristics of the user identified by the capture device 20, or the system 10 may use the features of a well-known boxer or portray the physique of a professional boxer for the visual representation that maps to the user's motions. The computing environment 12 may also use the audiovisual device 16 to provide a visual representation of a boxing opponent 38 to the user 18. Thus, according to an example embodiment, the computer environment 12 and the capture device 20 of the target recognition, analysis, and tracking system 10 may be used to recognize and analyze the motion of the user 18 in physical space such that the punch may be interpreted as a game control of the player avatar 40 in game space. The motion of the user 18 that is recognized as the punch may be defined in a package of gestures applicable to the system, program, computer interface, etc.

Other movements by the user 18 may also be interpreted as other controls or actions, such as controls to bob, weave, shuffle, block, jab, or throw a variety of different power punches. Furthermore, some movements may be interpreted as controls that may correspond to actions other than controlling the player avatar 40. For example, the player may use movements to end, pause, or save a game, select a level, view high scores, communicate with a friend, etc. Additionally, a full range of motion of the user 18 may be available, used, and analyzed in any suitable manner to interact with an application.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

A user's gestures or motion may be interpreted as controls that may correspond to actions other than controlling the player avatar 40. For example, the player may use movements to end, pause, or save a game, select a level, view high scores, communicate with a friend, etc. According to other example embodiments, the target recognition, analysis, and tracking system 10 may interpret target movements for controlling aspects of an operating system and/or application that are outside the realm of games. For example, virtually any controllable aspect of an operating system and/or application may be controlled by movements of the target such as the user 18.

The user's gesture may be controls applicable to an operating system, non-gaming aspects of a game, or a non-gaming application. The user's gestures may be interpreted as object manipulation, such as controlling a user interface. For example, consider a user interface having blades or a tabbed interface lined up vertically left to right, where the selection of each blade or tab opens up the options for various controls within the application or the system. The system may identify the user's hand gesture for movement of a tab, where the user's hand in the physical space is virtually aligned with a tab in the application space. The gesture, including a pause, a grabbing motion, and then a sweep of the hand to the left, may be interpreted as the selection of a tab, and then moving it out of the way to open the next tab.

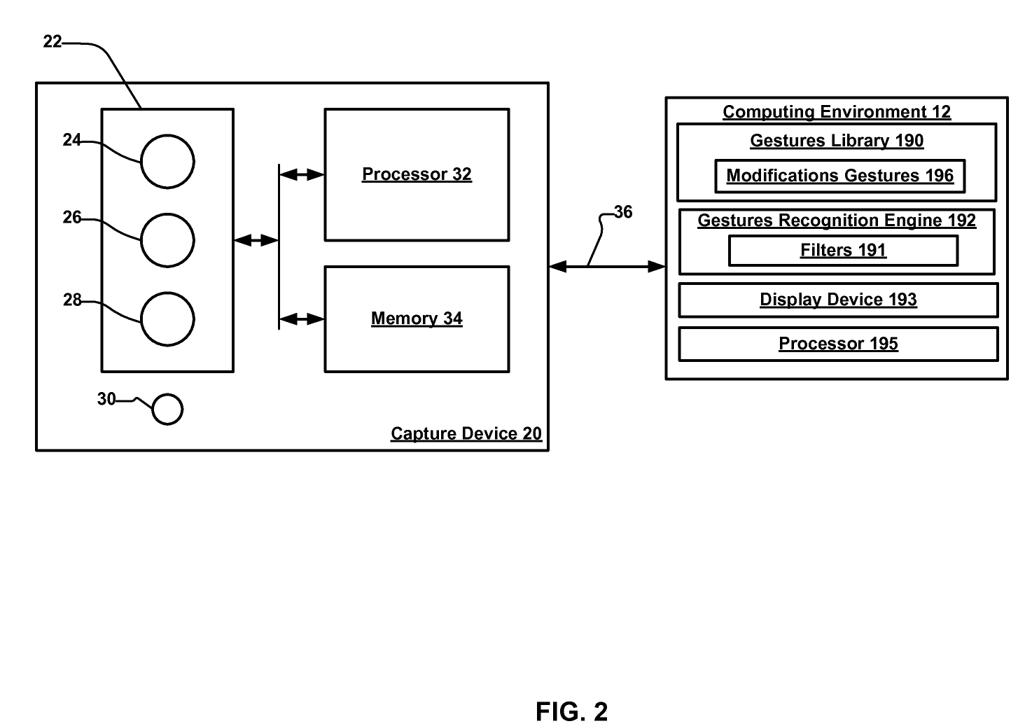

FIG. 2 illustrates an example embodiment of a capture device 20 that may be used for target recognition, analysis, and tracking, where the target can be a user or an object. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device to a particular location on the targets or objects.

According to another embodiment, the capture device 20 may include two or more physically separated cameras that may view a scene from different angles, to obtain visual stereo data that may be resolved to generate depth information

The capture device 20 may further include a microphone 30, or an array of microphones. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. The computing environment 12 may then use the skeletal model, depth information, and captured images to, for example, control an application such as a game or word processor. For example, as shown, in FIG. 2, the computing environment 12 may include a gestures library 190.

As shown, in FIG. 2, the computing environment 12 may include a gestures library 190 and a gestures recognition engine 192. The gestures recognition engine 192 may include a collection of gesture filters 191. Each filter 191 may comprise information defining a gesture along with parameters, or metadata, for that gesture. For instance, a throw, which comprises motion of one of the hands from behind the rear of the body to past the front of the body, may be implemented as a gesture filter comprising information representing the movement of one of the hands of the user from behind the rear of the body to past the front of the body, as that movement would be captured by a depth camera. Parameters may then be set for that gesture. Where the gesture is a throw, a parameter may be a threshold velocity that the hand has to reach, a distance the hand must travel (either absolute, or relative to the size of the user as a whole), and a confidence rating by the recognizer engine that the gesture occurred. These parameters for the gesture may vary between applications, between contexts of a single application, or within one context of one application over time. These parameters may also vary for gestures that are remapped. For example, a standard gesture for a throwing motion, comprising the described motion of the user's hand and arm, may be remapped to motion of the user's leg. Parameters may be set for the remapped gesture, such as a threshold velocity that the leg has to reach to recognize the gesture as a throwing gesture. The remapped gesture may define a separate gesture filter from the gesture filter that corresponds to the standard gesture data.

While it is contemplated that the gestures recognition engine may include a collection of gesture filters, where a filter may comprise code or otherwise represent a component for processing depth, RGB, or skeletal data, the use of a filter is not intended to limit the analysis to a filter. The filter is a representation of an example component or section of code that analyzes data of a scene received by a system, and comparing that data to base information that represents a gesture. As a result of the analysis, the system may produce an output corresponding to whether the input data corresponds to the gesture. The base information representing the gesture may be adjusted to correspond to the recurring feature in the history of data representative of the user's capture motion. The base information, for example, may be part of a gesture filter as described above. But, any suitable manner for analyzing the input data and gesture data is contemplated.

The data captured by the cameras 26, 28 and device 20 in the form of the skeletal model and movements associated with it may be compared to the gesture filters 191 in the gesture library 190 to identify when a user (as represented by the skeletal model) has performed one or more gestures. Thus, inputs to a filter such as filter 191 may comprise things such as joint data about a user's joint position, like angles formed by the bones that meet at the joint, RGB color data from the scene, and the rate of change of an aspect of the user. As mentioned, parameters may be set for the gesture. Outputs from a filter 191 may comprise things such as the confidence that a given gesture is being made, the speed at which a gesture motion is made, and a time at which the gesture occurs.

The computing environment 12 may include a processor 196 that can process the depth image to determine what targets are in a scene, such as a user 18 or an object in the room. This can be done, for instance, by grouping together of pixels of the depth image that share a similar distance value. The image may also be parsed to produce a skeletal representation of the user, where features, such as joints and tissues that run between joints are identified. There exist skeletal mapping techniques to capture a person with a depth camera and from that determine various spots on that user's skeleton, joints of the hand, wrists, elbows, knees, nose, ankles, shoulders, and where the pelvis meets the spine. Other techniques include transforming the image into a body model representation of the person and transforming the image into a mesh model representation of the person.

In an embodiment, the processing is performed on the capture device 20 itself, and the raw image data of depth and color (where the capture device comprises a 3D camera) values are transmitted to the computing environment 12 via link 36. In another embodiment, the processing is performed by a processor 32 coupled to the camera 402 and then the parsed image data is sent to the computing environment 12. In still another embodiment, both the raw image data and the parsed image data are sent to the computing environment 12. The computing environment 12 may receive the parsed image data but it may still receive the raw data for executing the current process or application. For instance, if an image of the scene is transmitted across a computer network to another user, the computing environment 12 may transmit the raw data for processing by another computing environment.

The computing environment 12 may use the gestures library 190 to interpret movements of the skeletal model and to control an application based on the movements. The computing environment 12 can model and display a representation of a user, such as in the form of an avatar or a pointer on a display, such as in a display device 193. Display device 193 may include a computer monitor, a television screen, or any suitable display device. For example, a camera-controlled computer system may capture user image data and display user feedback on a television screen that maps to the user's gestures. The user feedback may be displayed as an avatar on the screen such as shown in FIGS. 1A and 1B. The avatar's motion can be controlled directly by mapping the avatar's movement to those of the user's movements. The user's gestures may be interpreted control certain aspects of the application. It may be desirable to remap the way the system recognizes a particular gesture. For example, it may be desirable to remap the motion that defines a standard gesture to different motion. The remapping may result in modifying the gesture filter for the standard gesture, such as redefining the input, output, or parameters of the gesture filter, to correspond to a remapped gesture. The remapping information may supplement the standard gesture information or it may overwrite the standard gesture information. Alternately, the remapping could result in the generation of remapped gesture filters, such that separate remapped gesture filters and standard gesture filters are available.

According to an example embodiment, the target may be a human target in any position such as standing or sitting, a human target with an object, two or more human targets, one or more appendages of one or more human targets or the like that may be scanned, tracked, modeled and/or evaluated to generate a virtual screen, compare the user to one or more stored profiles and/or to store profile information 198 about the target in a computing environment such as computing environment 12. The profile information 198 may be in the form of user profiles, personal profiles, application profiles, system profiles, or any other suitable method for storing data for later access. The profile information 198 may include lookup tables for loading specific user profile information. A profile may be accessed upon entry of a user into a capture scene. The profile 198 may be program-specific, or be accessible globally, such as a system-wide profile. A profile 198, such as a user's profile, can be loaded for future use and it can be loaded for use by other users. The virtual screen may interact with an application that may be executed by the computing environment 12 described above with respect to FIGS. 1A-1B.

According to example embodiments, lookup tables may include user specific profile information. In one embodiment, the computing environment such as computing environment 12 may include stored profile data 198 about one or more users in lookup tables. The stored profile data 198 may include, among other things the targets scanned or estimated body size, skeletal models, body models, voice samples or passwords, the targets age, previous gestures, target limitations and standard usage by the target of the system, such as, for example a tendency to sit, left or right handedness, or a tendency to stand very near the capture device. This information may be used to determine if there is a match between a target in a capture scene and one or more user profiles 198, that, in one embodiment, may allow the system to adapt the virtual screen to the user, or to adapt other elements of the computing or gaming experience according to the profile 198.

One or more personal profiles 198 may be stored in computer environment 12 and used in a number of user sessions, or one or more personal profiles may be created for a single session only. Users may have the option of establishing a profile where they may provide information to the system such as a voice or body scan, age, personal preferences, right or left handedness, an avatar, a name or the like. Personal profiles may also be provided for “guests” who do not provide any information to the system beyond stepping into the capture space. A temporary personal profile may be established for one or more guests. At the end of a guest session, the guest personal profile may be stored or deleted.

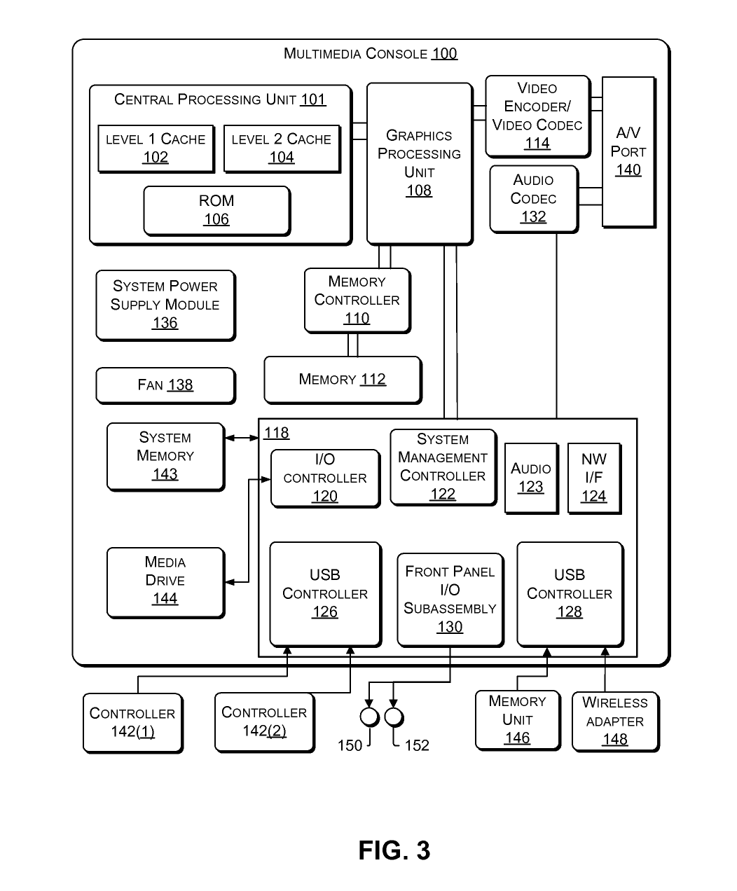

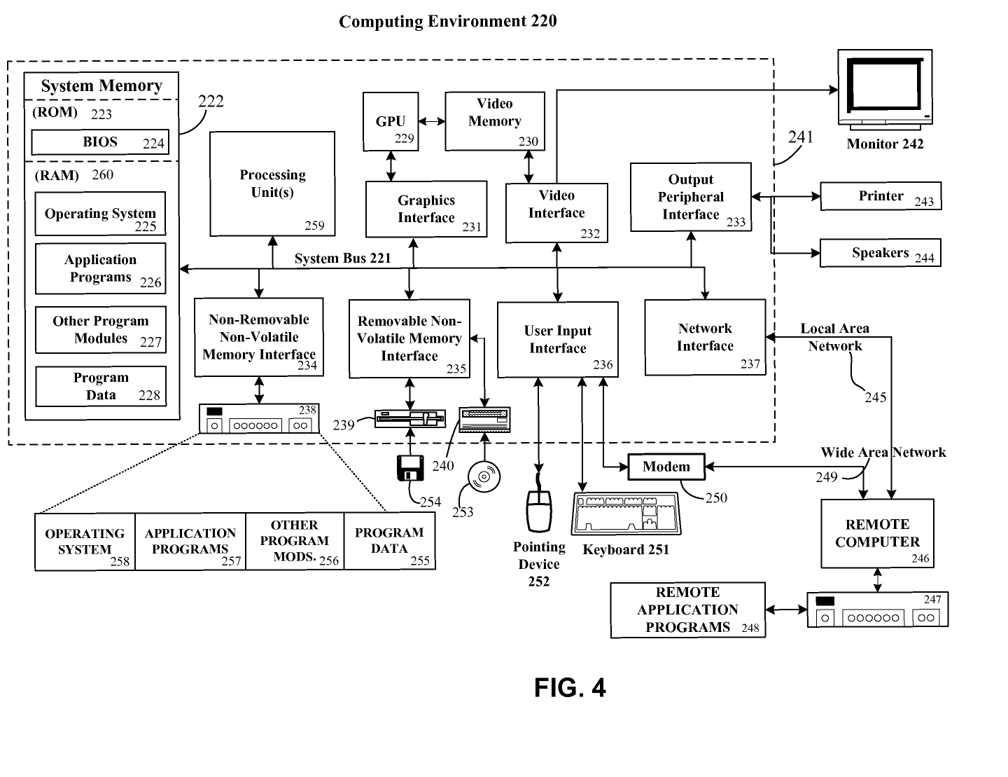

The gestures library 190, gestures recognition engine 192, and profile 198 may be implemented in hardware, software or a combination of both. For example, the gestures library 190,and gestures recognition engine 192 may be implemented as software that executes on a processor, such as processor 196, of the computing environment (or on processing unit 101 of FIG. 3 or processing unit 259 of FIG. 4).

It is emphasized that the block diagram depicted in FIGS. 2-4, described below are exemplary and not intended to imply a specific implementation. For example, the processor 195 or 32 in FIG. 1, the processing unit 101 of FIG. 3, and the processing unit 259 of FIG. 4, can be implemented as a single processor or multiple processors. Multiple processors can be distributed or centrally located. For example, the gestures library 190 may be implemented as software that executes on the processor 32 of the capture device or it may be implemented as software that executes on the processor 195 in the computing environment. Any combination of processors that are suitable for performing the techniques disclosed herein are contemplated. Multiple processors can communicate wirelessly, via hard wire, or a combination thereof.

Furthermore, as used herein, a computing environment may include a single computing device or a computing system. The computing environment may include non-computing components. The computing environment may include a display device, such as display device 193 shown in FIG. 2. A display device may be an entity separate but coupled to the computing environment or the display device may be integrated into a computing device that processes and displays, for example. Thus, a computing system, computing device, computing environment, computer, processor, or other computing component may be used interchangeably herein.

The gestures library 190 and filter parameters may be tuned for an application or a context of an application by a gesture tool. A context may be a cultural context, and it may be an environmental context. A cultural context refers to the culture of a user using a system. Different cultures may use similar gestures to impart markedly different meanings. For instance, an American user who wishes to tell another user to “look” or “use his eyes” may put his index finger on his head close to the distal side of his eye. However, to an Italian user, this gesture may be interpreted as a reference to the mafia.

Similarly, there may be different contexts among different environments of a single application. Take a first-user shooter game that involves operating a motor vehicle. While the user is on foot, making a first with the fingers towards the ground and extending the first in front and away from the body may represent a punching gesture. While the user is in the driving context, that same motion may represent a “gear shifting” gesture. There may also be one or more menu environments, where the user can save his game, select among his character's equipment or perform similar actions that do not comprise direct game-play. In that environment, this same gesture may have a third meaning, such as to select something or to advance to another screen.

Gestures may be grouped together into genre packages of complimentary gestures that are likely to be used by an application in that genre. Complimentary gestures—either complimentary as in those that are commonly used together, or complimentary as in a change in a parameter of one will change a parameter of another—may be grouped together into genre packages. These packages may be provided to an application, which may select at least one. A gesture package may include gestures that are packaged as remapped gestures or a gesture package may include options for remapping standard gestures to new data. Thus, the remapped gesture may be provided with the gesture package or the system or user may have the ability to remap a standard gesture. The application may tune, or modify, the parameter of a standard or remapped gesture or gesture filter to best fit the unique aspects of the application. When that parameter is tuned, a second, complimentary parameter (in the inter-dependent sense) of either the gesture or a second gesture is also tuned such that the parameters remain complimentary. Genre packages for video games may include genres such as first-user shooter, action, driving, and sports.

FIG. 3 illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16MB), CPU and GPU cycles (e.g., 5%), networking bandwidth (e.g., 8 kbs.), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100.

FIG. 4 illustrates another example embodiment of a computing environment 220 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

The computer readable storage media described above may have stored thereon instructions for remapping a gesture. The computer readable instructions may comprise selecting a gesture filter that corresponds to the gesture for remapping and interpreting data received from a capture device that is representative of a user's motion in a physical space. The instructions may comprise remapping the gesture to the user's motions as interpreted, wherein remapping the gesture may comprise modifying the gesture filter to correspond to the interpreted data.

The computer readable storage media described above may also have stored thereon instructions for remapping a package of complementary gesture filters. The instructions may comprise providing a package comprising a plurality of filters, each filter comprising information about a gesture, at least one filter being complementary with at least one other filter in the package. The instructions may comprise remapping a first value to a parameter of a first filter to correspond to data received from a capture device that is representative of a user's motion in a physical space and, as a result, remapping a second value to a second parameter of a second filter, the second value determined using the first value.

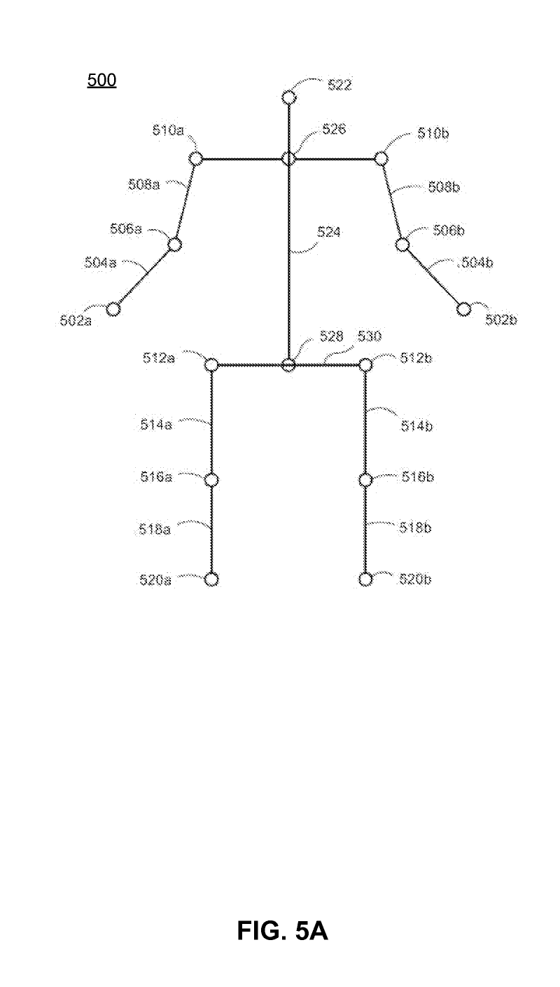

FIG. 5A depicts an example skeletal mapping of a user that may be generated from image data captured by the capture device 20. In this embodiment, a variety of joints and bones are identified: each hand 502, each forearm 504, each elbow 506, each bicep 508, each shoulder 510, each hip 512, each thigh 514, each knee 516, each foreleg 518, each foot 520, the head 522, the torso 524, the top 526 and bottom 528 of the spine, and the waist 530. Where more points are tracked, additional features may be identified, such as the bones and joints of the fingers or toes, or individual features of the face, such as the nose and eyes.

Through moving his body, a user may create gestures. A gesture comprises a motion or pose by a user that may be captured as image data and parsed for meaning. A gesture may be dynamic, comprising a motion, such as mimicking throwing a ball. A gesture may be a static pose, such as holding one's crossed forearms 504 in front of his torso 524. A gesture may also incorporate props, such as by swinging a mock sword. A gesture may comprise more than one body part, such as clapping the hands 502 together, or a subtler motion, such as pursing one's lips.

A user's gestures may be used for input in a general computing context. For instance, various motions of the hands 502 or other body parts may correspond to common system wide tasks such as navigate up or down in a hierarchical list, open a file, close a file, and save a file. For instance, a user may hold his hand with the fingers pointing up and the palm facing the capture device 20. He may then close his fingers towards the palm to make a first, and this could be a gesture that indicates that the focused window in a window-based user-interface computing environment should be closed. Gestures may also be used in a video-game-specific context, depending on the game. For instance, with a driving game, various motions of the hands 502 and feet 520 may correspond to steering a vehicle in a direction, shifting gears, accelerating, and braking. Thus, a gesture may indicate a wide variety of motions that map to a displayed user representation, and in a wide variety of applications, such as video games, text editors, word processing, data management, etc.

A user may generate a gesture that corresponds to walking or running, by walking or running in place himself. For example, the user may alternately lift and drop each leg 512-520 to mimic walking without moving. The system may parse this gesture by analyzing each hip 512 and each thigh 514. A step may be recognized when one hip-thigh angle (as measured relative to a vertical line, wherein a standing leg has a hip-thigh angle of 0°, and a forward horizontally extended leg has a hip-thigh angle of 90°) exceeds a certain threshold relative to the other thigh. A walk or run may be recognized after some number of consecutive steps by alternating legs. The time between the two most recent steps may be thought of as a period. After some number of periods where that threshold angle is not met, the system may determine that the walk or running gesture has ceased.

Given a “walk or run” gesture, an application may set values for parameters associated with this gesture. These parameters may include the above threshold angle, the number of steps required to initiate a walk or run gesture, a number of periods where no step occurs to end the gesture, and a threshold period that determines whether the gesture is a walk or a run. A fast period may correspond to a run, as the user will be moving his legs quickly, and a slower period may correspond to a walk.

A gesture may be associated with a set of default parameters at first that the application may override with its own parameters. In this scenario, an application is not forced to provide parameters, but may instead use a set of default parameters that allow the gesture to be recognized in the absence of application-defined parameters. Information related to the gesture may be stored for purposes of pre-canned animation.

There are a variety of outputs that may be associated with the gesture. There may be a baseline “yes or no” as to whether a gesture is occurring. There also may be a confidence level, which corresponds to the likelihood that the user's tracked movement corresponds to the gesture. This could be a linear scale that ranges over floating point numbers between 0 and 1, inclusive. Wherein an application receiving this gesture information cannot accept false-positives as input, it may use only those recognized gestures that have a high confidence level, such as at least 0.95. Where an application must recognize every instance of the gesture, even at the cost of false-positives, it may use gestures that have at least a much lower confidence level, such as those merely greater than 0.2. The gesture may have an output for the time between the two most recent steps, and where only a first step has been registered, this may be set to a reserved value, such as −1 (since the time between any two steps must be positive). The gesture may also have an output for the highest thigh angle reached during the most recent step.

Another exemplary gesture is a “heel lift jump.” In this, a user may create the gesture by raising his heels off the ground, but keeping his toes planted. Alternatively, the user may jump into the air where his feet 520 leave the ground entirely. The system may parse the skeleton for this gesture by analyzing the angle relation of the shoulders 510, hips 512 and knees 516 to see if they are in a position of alignment equal to standing up straight. Then these points and upper 526 and lower 528 spine points may be monitored for any upward acceleration. A sufficient combination of acceleration may trigger a jump gesture. A sufficient combination of acceleration with a particular gesture may satisfy the parameters of a transition point.

Given this “heel lift jump” gesture, an application may set values for parameters associated with this gesture. The parameters may include the above acceleration threshold, which determines how fast some combination of the user's shoulders 510, hips 512 and knees 516 must move upward to trigger the gesture, as well as a maximum angle of alignment between the shoulders 510, hips 512 and knees 516 at which ajump may still be triggered. The outputs may comprise a confidence level, as well as the user's body angle at the time of the jump.

Setting parameters for a gesture based on the particulars of the application that will receive the gesture is important in accurately identifying gestures. Properly identifying gestures and the intent of a user greatly helps in creating a positive user experience.

An application may set values for parameters associated with various transition points to identify the points at which to use pre-canned animations. Transition points may be defined by various parameters, such as the identification of a particular gesture, a velocity, an angle of a target or object, or any combination thereof. If a transition point is defined at least in part by the identification of a particular gesture, then properly identifying gestures assists to increase the confidence level that the parameters of a transition point have been met.

Another parameter to a gesture may be a distance moved. Where a user's gestures control the actions of an avatar in a virtual environment, that avatar may be arm's length from a ball. If the user wishes to interact with the ball and grab it, this may require the user to extend his arm 502-510 to full length while making the grab gesture. In this situation, a similar grab gesture where the user only partially extends his arm 502-510 may not achieve the result of interacting with the ball. Likewise, a parameter of a transition point could be the identification of the grab gesture, where if the user only partially extends his arm 502-510, thereby not achieving the result of interacting with the ball, the user's gesture also will not meet the parameters of the transition point.

A gesture or a portion thereof may have as a parameter a volume of space in which it must occur. This volume of space may typically be expressed in relation to the body where a gesture comprises body movement. For instance, a football throwing gesture for a right-handed user may be recognized only in the volume of space no lower than the right shoulder 510a, and on the same side of the head 522 as the throwing arm 502a-310a. It may not be necessary to define all bounds of a volume, such as with this throwing gesture, where an outer bound away from the body is left undefined, and the volume extends out indefinitely, or to the edge of scene that is being monitored.

FIG. 5B provides further details of one exemplary embodiment of the gesture recognizer engine 192 of FIG. 2. As shown, the gesture recognizer engine 192 may comprise at least one filter 519 to determine a gesture or gestures. A filter 519 comprises information defining a gesture 526 (hereinafter referred to as a “gesture”), and may comprise at least one parameter 528, or metadata, for that gesture 526. For instance, a throw, which comprises motion of one of the hands from behind the rear of the body to past the front of the body, may be implemented as a gesture 526 comprising information representing the movement of one of the hands of the user from behind the rear of the body to past the front of the body, as that movement would be captured by the depth camera. Parameters 528 may then be set for that gesture 526. Where the gesture 526 is a throw, a parameter 528 may be a threshold velocity that the hand has to reach, a distance the hand must travel (either absolute, or relative to the size of the user as a whole), and a confidence rating by the recognizer engine 192 that the gesture 526 occurred. These parameters 528 for the gesture 526 may vary between applications, between contexts of a single application, or within one context of one application over time.

Filters may be modular or interchangeable. In an embodiment, a filter has a number of inputs, each of those inputs having a type, and a number of outputs, each of those outputs having a type. In this situation, a first filter may be replaced with a second filter that has the same number and types of inputs and outputs as the first filter without altering any other aspect of the recognizer engine 192 architecture. For instance, there may be a first filter for driving that takes as input skeletal data and outputs a confidence that the gesture 526 associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

A filter need not have a parameter 528. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Inputs to a filter may comprise things such as joint data about a user's joint position, like angles formed by the bones that meet at the joint, RGB color data from the scene, and the rate of change of an aspect of the user. Outputs from a filter may comprise things such as the confidence that a given gesture is being made, the speed at which a gesture motion is made, and a time at which a gesture motion is made.

A context may be a cultural context, and it may be an environmental context. A cultural context refers to the culture of a user using a system. Different cultures may use similar gestures to impart markedly different meanings. For instance, an American user who wishes to tell another user to “look” or “use his eyes” may put his index finger on his head close to the distal side of his eye. However, to an Italian user, this gesture may be interpreted as a reference to the mafia.

Similarly, there may be different contexts among different environments of a single application. Take a first-person shooter game that involves operating a motor vehicle. While the user is on foot, making a first with the fingers towards the ground and extending the first in front and away from the body may represent a punching gesture. While the user is in the driving context, that same motion may represent a “gear shifting” gesture. There may also be one or more menu environments, where the user can save his game, select among his character's equipment or perform similar actions that do not comprise direct game-play. In that environment, this same gesture may have a third meaning, such as to select something or to advance to another screen.

The gesture recognizer engine 192 may have a base recognizer engine 517 that provides functionality to a gesture filter 519. In an embodiment, the functionality that the recognizer engine 517 implements includes an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

Filters 519 are loaded and implemented on top of the base recognizer engine 517 and can utilize services provided by the engine 517 to all filters 519. In an embodiment, the base recognizer engine 517 processes received data to determine whether it meets the requirements of any filter 519. Since these provided services, such as parsing the input, are provided once by the base recognizer engine 517 rather than by each filter 519, such a service need only be processed once in a period of time as opposed to once per filter 519 for that period, so the processing required to determine gestures is reduced.

An application may use the filters 519 provided by the recognizer engine 192, or it may provide its own filter 519, which plugs in to the base recognizer engine 517. In an embodiment, all filters 519 have a common interface to enable this plug-in characteristic. Further, all filters 519 may utilize parameters 528, so a single gesture tool as described below may be used to debug and tune the entire filter system 519.

These parameters 528 may be tuned for an application or a context of an application by a gesture tool 521. In an embodiment, the gesture tool 521 comprises a plurality of sliders 523, each slider 523 corresponding to a parameter 528, as well as a pictorial representation of a body 524. As a parameter 528 is adjusted with a corresponding slider 523, the body 524 may demonstrate both actions that would be recognized as the gesture with those parameters 528 and actions that would not be recognized as the gesture with those parameters 528, identified as such. This visualization of the parameters 528 of gestures provides an effective means to both debug and fine tune a gesture.

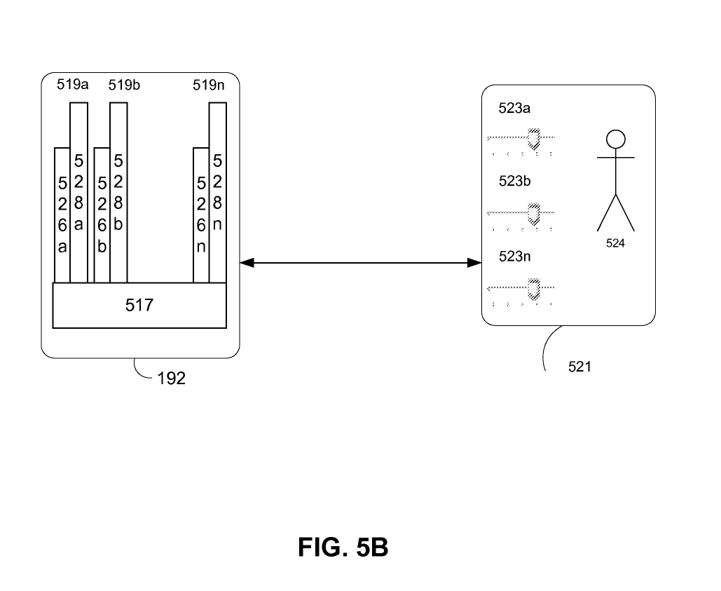

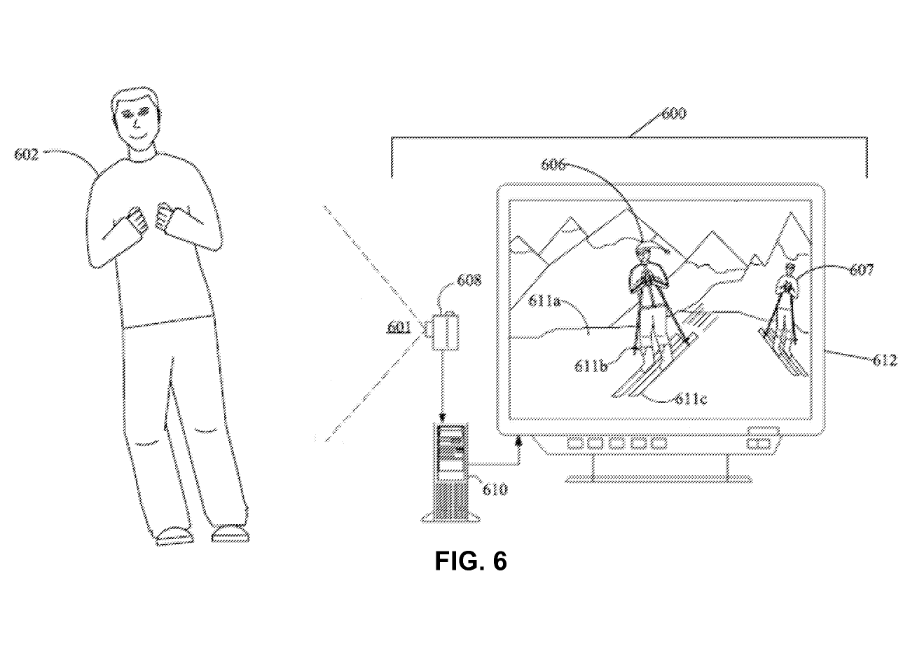

FIG. 6 illustrates an example of a system 600 that captures a target 602 in a physical space 601 and maps it to a visual representation in a virtual environment. The system 600 may be used with the disclosed gesture extending and remapping techniques. The target may be any object or user in the physical space 601. As shown in FIG. 6, system 600 may comprise a capture device 608, a computing device 610, and a display device 612. For example, the capture device 608, computing device 610, and display device 612 may comprise any suitable device that performs the desired functionality, such as the devices described with respect to FIGS. 1A-5B. It is contemplated that a single device may perform all of the functions in system 600, or any combination of suitable devices may perform the desired functions. For example, the computing device 610 may provide the functionality described with respect to the computing environment 12 shown in FIG. 2 or the computer in FIG. 3. The computing device 610 may also comprise its own camera component or may be coupled to a device having a camera component, such as capture device 608.

FIG. 6 represents the user's 602 motion at a discrete point in time and the display 612 displays a visual representation 606 that corresponds to the user 602 at that point of time. The system 600 may identify a gesture from the user's 602 motion by evaluating the user's 602 position in a single frame of capture data or over a series of frames. The rate that frames of image data are captured and displayed determines the level of continuity of the displayed motion of the visual representation. Though additional frames of image data may be captured and displayed, the frame depicted in FIG. 6 is selected for exemplary purposes.

The system 600 may track the target 602 in the physical space 601 such that the visual representation 606 maps to the target 602 or the motion captured in the physical space 601. The user's 602 motion may correspond to a gesture that controls an aspect of the system 600 or application. In an example embodiment comprising remapped gestures, the system 600 may identify motion that corresponds to a remapped gesture. In another example embodiment, the system 600 may track the target 602 in the physical space 601 and remap a gesture to correspond to that motion.

In this example, a depth camera 608 captures a scene 601 in a physical space 601 in which a user 602 is present. According to one embodiment, image data may include a depth image or an image from a depth camera and/or RGB camera, or an image on any other detector. For example, camera 608 may process the image data and use it to determine the shape, colors, and size of a target. In this example, the user 602 in the physical space 601 is the target 602 captured by a depth camera 608 that processes the depth information and/or provides the depth information to a computer, such as a computer 610.

The depth information is interpreted for display of a visual representation 606, such as an avatar. Each target or object that matches the human pattern may be scanned to generate a model such as a skeletal model, a mesh human model, or the like associated therewith. For example, a skeletal model, such as that shown in FIG. 5A, of the user 602 may be generated. Using for example, the depth values in a plurality of observed pixels that are associated with a human target and the extent of one or more aspects of the human target such as the height, the width of the head, or the width of the shoulders, or the like, the size of the human target may be determined. The depth camera 608 or, as shown, a computing device 610 to which it is coupled, may output to a display 612.

In this example, the user 602 is playing a skiing game and the visual representation 606 of the user 602 is shown as avatar 606. The avatar 606 is shown on a virtual mountain 611a, with virtual ski poles 611b, and virtual skis 611c. The user's 602 motions are mapped to the avatar 606 and may also correspond to gestures that control aspects of the skiing game. Thus, the user 602 performs motions in the physical space 601 that translate to certain controls in the virtual space. As shown, the user 602 motions in the physical space 601 to represent the holding of ski poles, crouches slightly, and leans to the left. These motions correspond to gestures that start the avatar's 606 descent down a virtual mountain 61 la, where the avatar skis in a direction to the right to correspond to the user's 602 gestures.

The virtual space may comprise a representation of a three-dimensional space that a user 602 may affect—say by moving an object—through user input. That virtual space may be a completely virtual space that has no correlation to a physical space 601 of the user 602—such as a representation of a castle or a classroom not found in physical reality. That virtual space may also be based on a physical space 601 that the user has no relation to, such as a physical classroom in Des Moines, Iowa that the user 602 has never seen or been inside. For purposes of this example, the user 602 is playing a skiing game. The avatar 603 that maps to the user's 602 motions is the portion of the display that is controlled by the user's 602 motions in the physical space 601. The background (e.g., mountain 611a, other users) and props (skis 611c, ski poles 611b) are animations that are packaged with the skiing game application and do not correlate to the physical space 601. The second avatar 607 may correspond to a second user in the physical space 601 or may be a part of the package for the skiing application. Thus, the only aspect of the display that is controlled by motion in the physical space 601, in this example, is the avatar 610 that maps to the user's 602 motions.

Certain aspects of an animation of a user's gesture may not correspond directly to the user's motion in the physical space. For example, a skiing game may comprise many gestures that correspond to the various types of jumps a user may want to perform. The jumps desired in the skiing game may not correspond directly to the user's motions in the physical space and it is desirable to provide an animation based on the expected or intended motion. For example, a user cannot jump or move the same in the physical space as a person skiing if the user is not actually skiing down a mountain. Further, additional animations may be included. For example, if the user does a jumping motion, the animation may include a bending down motion before the jump occurs. The animation may be based on the motion that would naturally occur when a gesture is performed.

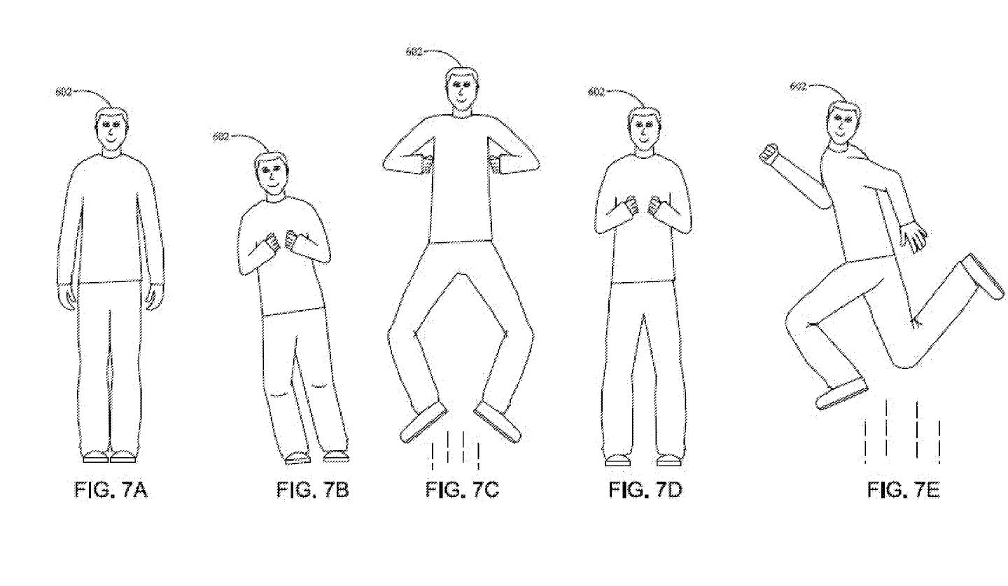

FIG. 7A-7E depict images of a user's motion in the physical space that correspond to a skiing game application. Each of FIGS. 7A-7E depicts an example snapshot of the user taken throughout the user's motion for which the capture device may receive data. It is to be understood the snapshots are taken at exemplary points of time, and that additional data and/or images may be captured between each of FIGS. 7A-7E. While the depth camera 608 may capture a series of still images, such that in any one image the user appears to be stationary, the user may be moving in the course of performing this gesture (as opposed to a stationary gesture, as discussed supra). The system is able to take this series of poses in each still image, and from that determine the moving gesture that the user is making. Together, the images may be recognized in the skiing game application as various controls in the game.

As shown in FIG. 7A, the user 602 is playing a skiing application, such that the user observes a virtual skiing environment on the screen, such as screen 612 shown in FIG. 6. The virtual skiing environment includes the skiing mountain, for example. The user shown in FIG. 7A is an example of the user positioning himself or herself in the physical space to align the user's avatar, that maps to the user's motions, with the top of the virtual mountain. FIGS. 7B-7E depict additional example snapshots of the user's motions that include gestures used to control aspects of the skiing game. At FIG. 7B, the user, holding his or her arms to correspond to a typical position for holding ski poles while skiing, gestures by leaning to the left, crouching slightly. The gestures may be recognized as controls for initiating the avatar's descent down the virtual mountain in the skiing game, and controlling the direction that the avatar's skis, such as right in this example.

FIG. 7C represents the user's jumping gesture in the physical space, which corresponds to a jump of the avatar in the skiing game, such as a jump over a small hill on the mountain. FIG. 7D represents the user after the jump, holding the ski poles under his or her arms, crouched slightly, but standing upright with no lean. The user's motion in the physical space may be recognized as a gesture for controlling the avatar to ski straight. FIG. 7E depicts a user's gestures that correspond to a scissor kick ski jump, as may be recognized and mapped to the avatar to control the avatar's motion in the virtual space.

The motions represented in FIGS. 7A-7E may be mapped to the avatar simply for display purposes. However, as described above, the user's motions in the physical space may correspond to various gestures that control aspects of the system or application. For example, the system may capture data corresponding to the user's jumping motion in the physical space and identify the particular type of jump that corresponds to the jumping gesture. The gesture may comprise a simple straight up and down jump, such as that shown in FIG. 7C, or the gesture may comprise a special jump, such as the scissor kickjump shown in FIG. 7E. The gesture may control an aspect of the application and may determine failure or success in the game. The gesture may control non-gaming aspects of the application or system, such as powering off, opening a file, etc.

The motions represented in FIGS. 7A-7E may correspond to standard gestures that are part of a gestures package for the skiing game. Often, the motion that corresponds to a standard gestures is intuitively defined. For example, the user's motion that corresponds to a leaning gesture that controls the avatar's lean as it relates to the skiing game comprises a user's lean in the physical space. Similarly, the user's jump shown in FIGS. 7C and 7E that correspond to the up and down jumping gesture and the scissor kick jumping gesture, respectively, intuitively correspond to the desired gesture to be recognized. Some standard gestures may not correspond to intuitive motion, sometimes due to necessity. For example, a flying gesture may not comprise a flying motion in the physical space but rather may comprise a user standing in the physical space, swaying from side to side with the user's arms out to either side.

A system or application that utilizes gestures for aspects of control comes with a package of standard gestures, where the motion corresponding to the gestures is defined by the provided package. In many cases, games or navigation systems have only a single “correct” entry, and very specific movements are necessary for the gesture to be recognized and/or for achieving success in the game. This is often the case for games with a competitive nature, often having very clear goals for achieving success in the game. The strict requirements for success often increase the learning barrier for some users and potentially alienate users who are not able to perform the task for some reason. For example, a user may be physically challenged, such as having limited mobility caused by an injury, arthritis, or a handicap, for example. The user may be mentally challenged, such as having a learning disability or having diminished mental capacity due to recovering from an accident.

In an example embodiment, a system and/or application may include gestures that are not yet defined, as they may be gestures that do not correspond to a realistic motion in the physical space and it may be desirable that the user have options to set the motion for the gesture in a way that suits the user. In this manner, the package of standard gestures may include mappable gestures.

In another example, a system that can identify a user, track the user's behaviors, and remap gestures on behalf of that user. The remapped gestures may allow for a more positive user experience. By allowing an “incorrect” entry to become a “correct” entry based on a user's failed attempts, history data, selective remapping, or the like, the application may be more approachable and accessible to different types of users.

In another example embodiment, a user may select to remap gestures, such as by selecting gestures in the package of standard gestures that are already mapped to particular motions and remapping them to different motions. The standard gesture may be recognized by motion in such a manner that certain users are unable to successfully perform the motion that corresponds to the control of that gesture. For example, consider a user that has a broken leg, or paralysis of a lower limb, or limited use of the lower body. Performing gestures that comprise standing, jumping motions from a standing position, or leaning in the standing position, as shown FIGS. 7A-7E, may be difficult, uncomfortable, or even impossible for certain users to perform. Thus, a user may select to initiate remapping procedure.

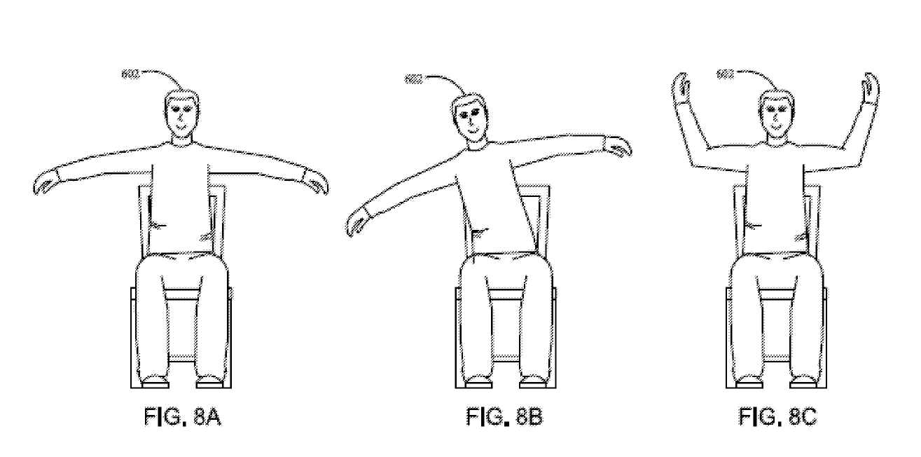

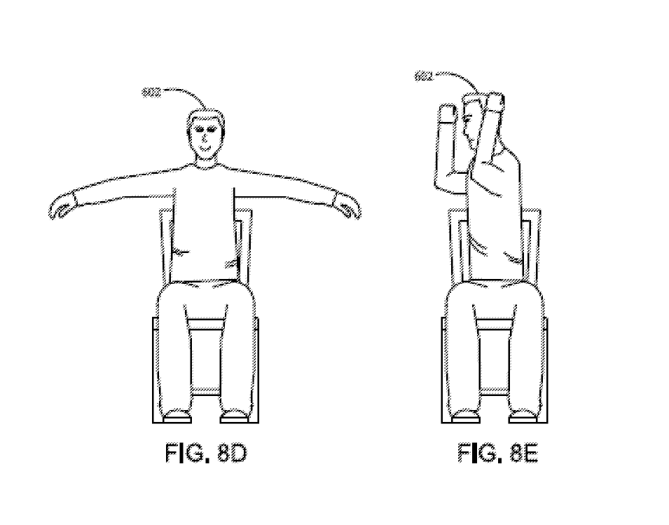

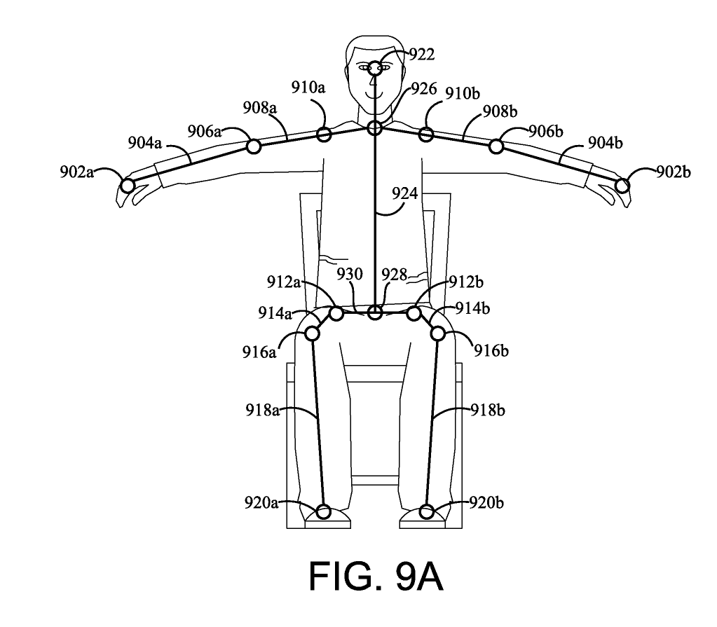

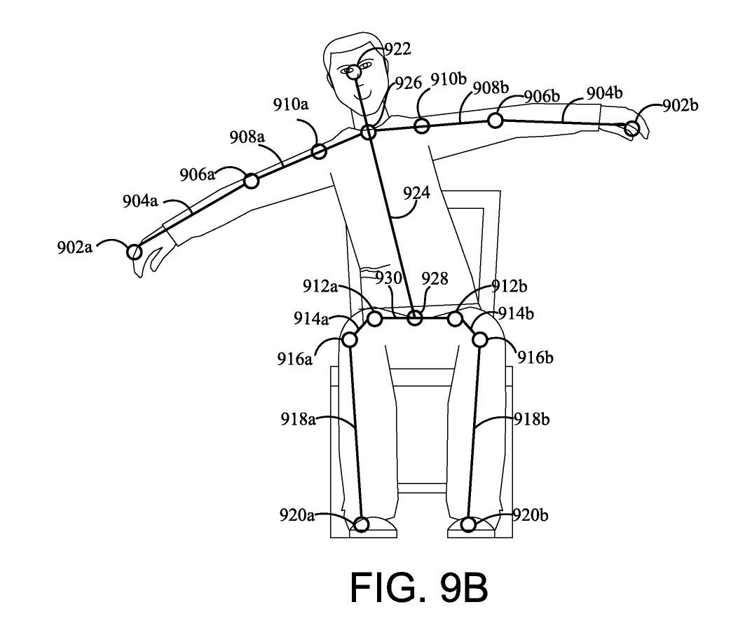

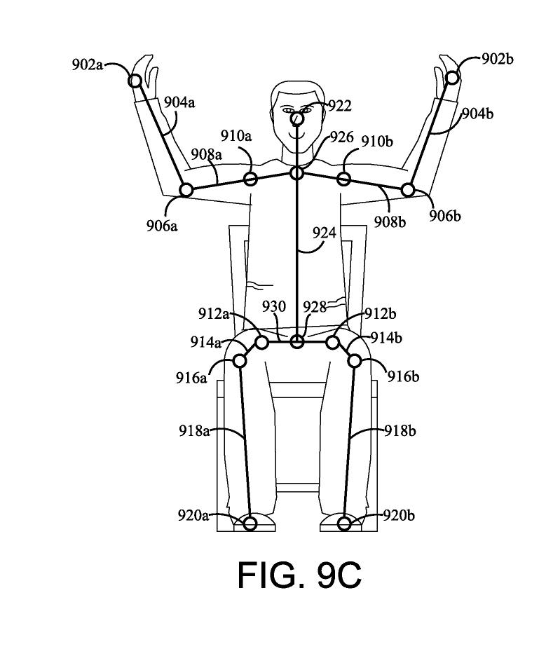

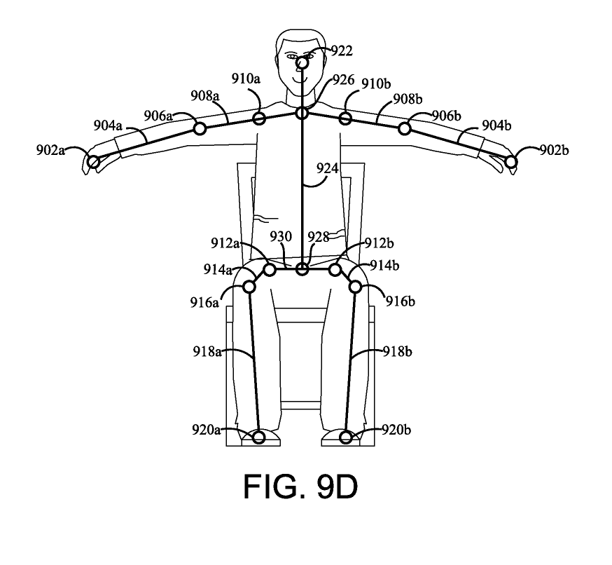

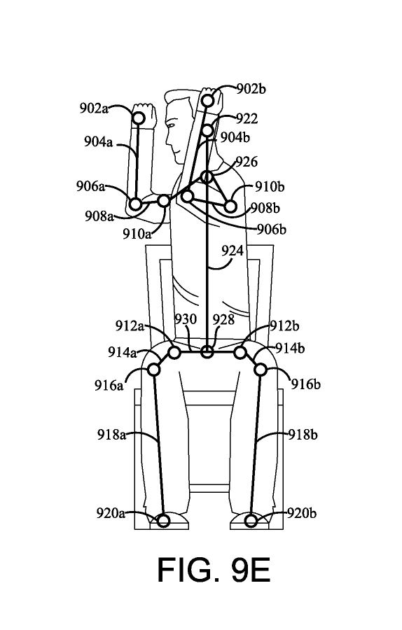

FIGS. 8A-8E and 9A-9E depict an example of a user's motions that could be used to remap the motion that defines the standard gestures shown in FIGS. 7A-7E. Each of FIGS. 8A-8E depict an example snapshot of the user's motions that could remap to the skiing gestures shown by the motions in FIGS. 7A-7E. In this example, the system remaps gestures to motions that do not require significant movement of the user's lower body. As shown, the motions in FIGS. 8A-8E primarily utilize the user's upper body motion while the user is in a seated position. The example motions, therefore, provide an example of varying motions that a user with limited use of his or her lower body might use for remapping. The gesture data, as it was originally mapped, may be completely remapped to the new user data. For example, if the user or the system selects a gesture for remapping, the original data mapped to the standard gesture may be replaced with the received data for the user. The resulting remapped data may be similar in some aspects to the data for the standard gesture, but the data originally mapped to the standard gesture may be written over by the remapped data. For example, upon selection for remapping, the gesture filter parameters for a selected gesture may be initialized or reset. The received data may be used to generate an entirely new set of gesture filter parameters.

While the remapping procedure is described with respect to motion, it is to be understood that motion refers to dynamic motion but also static motion, such as a still pose. Further, remapping the gesture may comprise vocal remapping. For example, consider a user with limited lower body mobility playing an ice skating game application. The user may remap ice skating gestures that comprise the upper and lower body to be recognized solely from upper body motion. However, it may be desirable to use the same upper body motions for several skating moves. For example, a jump and spin gesture may comprise the same upper body motion for a jump with a single spin, a jump with a double spin. The standard gestures for each may be distinguished based on the lower body motion. Thus, for the remapped gesture that do not comprise any lower body motion, the user may user vocal direction along with the upper body motion. For example, the user may remap the jump and spin gesture to correspond to a twisting of the upper body with the elbows up and to the side, and hands positioned in front of the user. In order to demonstrate the jump and spin once gesture, the user may, along with the upper body motion, say “once.” Similarly, to demonstrate the jump and spin twice gesture, the user may, along with the same twisting upper body motion, say “twice.” The upper body motion and the vocal command may remap to the jump and spin gestures. In some cases, a standard gesture may be remapped to only vocal commands.

In an example embodiment, the user could select to remap these motions for the recognition of the same gestures that are recognized as a result of the motions shown in FIGS. 7A-7E that use both the upper and lower body. Consider a user that has limited mobility of his or her lower body. The user could initiate the skiing program and opt to enter into a remapping procedure. For each of the gestures that are packaged with the skiing program, the user may have an option to remap the motion(s) that defines the gesture. For example, the user may select the up and down jumping gesture that may be packaged as a standard gesture and defined by the motion represented by FIG. 7C. The system may detect that the user is requesting to remap the standard up and down gesture that was packaged with the game. A capture device in the system may receive data related to the user's movement in the physical space, and the system may identify and interpret the received data as the motion the user desires to remap to the up and down jumping gesture.

In another example embodiment, the system could track the user's motions and identify that the user's motions continuously vary from the motion that is expected for performing a particular gesture. For example, if every time the system would expect the user to motion in the physical space as shown in FIG. 7C to cause the avatar to jump in the virtual space, the system may detect that the user continuously does not utilize his or her lower body. The system may combine the expectation of a particular gesture with history data pertaining to a particular user to determine that the standard gesture could be remapped to better suit the user.

The system may have an expectation for a particular gesture in a variety of circumstances. In an example embodiment, the point in the application may solicit a particular gesture and the system may expect that the user make motions to correspond to the particular gesture. For example, in a baseball game application, at the point when the user's avatar is to pitch to a batter, the system would be expect the user to make motions that correspond to a pitching gesture. The pitching gesture may be a standard gesture provided with the baseball game application, and may comprise motion that includes the lifting of the user's leg and an overhand throwing motion. The system may detect that, at this point in the game, the user continuously makes a sidearm or underhand motion. Consider a user that cannot make an overhand throwing motion, maybe due to an injury that prevents the user from full use of his or her arm. The system's capability of remapping gestures based on history data for a particular user may therefore provide for a more positive user experience.

In another example embodiment, the system or application may provide training for the standard set of gestures. During the training session, the system may identify a user's varied motion that differs from the motion mapped to a particular gesture. The system may determine that the gesture should be remapped to the motion the user is performing. The remapped gesture may be saved and loaded for the user for future use, such as in a user profile. The remapped gestures may be available to the user for the particular application or may be available system-wide.

While the system may remap gestures based on a particular user, the remapped gestures may be available to other users. For example, if a user remaps gestures for an application based on the limited use of mobility of the user's legs, a second user may select to utilize the same remapped gestures. In this example, the system remaps gestures to motions that do not require significant movement of the user's lower body. Thus, other users that desire similar changes to the standard gestures may benefit by using the remapped gestures. The second user may have a similar issue, such as limited mobility of the lower body. The second user may simply wish to perform similar motions as the first user such that they can share in the same experience while playing the game. For example, a parent may user the remapped gestures that are remapped for a child that has limited lower body movement such that the child is less aware of the differences due to the child's inabilities.

The system may also have gestures that are identified in the package of standard gestures that are not yet mapped to a particular motion, leaving it to the user to provide the motion that should correspond to the particular gesture.

Upon an identification that a gesture is to be mapped or remapped, the system may identify a segment of time or data received by a capture device to remap to the gesture. For example, a capture device may capture each of the user's motions in FIGS. 8A-8E and remap the standard gestures to correspond to different motion. For example, a user may select a remapping procedure for the up and down jumping gesture, where the standard gesture is recognized by the user's motion represented by FIG. 7C. The user may signal to the system that the user is remapping the up and down motion. The capture device may receive data representative of the user's motions and redefine the motion for the up and down gesture with the received data. For example, the user's motion, that comprises raising both of his or her arms up on either side of his or her head, may be received by the capture device and associated with the gesture.

The gesture data, as it was originally mapped, may be completely remapped to the new user data. For example, if the user or the system selects a gesture for remapping, the original data mapped to the standard gesture may be replaced with the received data for the user. The resulting remapped data may be similar in some aspects to the data for the standard gesture, but the data originally mapped to the standard gesture may be written over by the remapped data. For example, upon selection for remapping, the gesture filter parameters for a selected gesture may be initialized or reset. The received data may be used to generate an entirely new set of gesture filter parameters.

Tolerances may be added with regards to the user's motion to allow for certain amounts of variation when performing the motion following the remapping. For example, the velocity of the user's arms as they move upwards, and the position of each arm away from the head, may be set for the remapped gesture as a range. Thus, the captured motion during the remapping procedure may provide the base motion for the gesture, but variations from the captured motion in specified ranges may be added. Thus, the user's motions can vary following the remapping but still be recognized as the remapped motion. Each gesture remapped may be selected and/or remapped separately, or some gestures may be complimentary, as described in more detail below, and be modified based on the modifications made to the parent gesture.

The example snapshots of motion shown in FIGS. 8A-8E could be the motion used to remap standard gestures in the skiing program. For example, the seated motion shown in FIG. 8A may be remapped to the user's pose, such as that shown in FIG. 7A, that initiates the avatar's descent down the virtual mountain. In FIG. 8A, the remapped gesture comprises the user holding his or her arms straight out to either side. In FIG. 8B, rather than the standing with a lean motion shown in FIG. 7B, the user leans to the right in the seated position, holding his or arms straight out at the side, but with the left arm up higher than the right arm. In FIG. 8C, rather than jumping as represented by FIG. 7C, the user may reach his or her arms up, lifting the user's hands to either side of the user's head. FIG. 8D is a repeat of the stagnant pose of FIG. 8A. And, in FIG. 8E, rather than a motion that comprises jumping and kicking each leg in the opposite direction shown in FIG. 7E, the user can remap the gesture to comprise lifting the arms up on either side of the user's head, and turning the upper body to one side. Certain aspects of an animation of the user's remapped gestures may not correspond directly to the user's motion in the physical space. Where gestures for various jumps in the skiing game are, such as to motion that comprises a user in a seated position and motioning with the upper body, it may be desirable to animate the user's motion to correspond to the gesture performed. For example, if a user is attempting the scissor kick by gesturing as shown in FIG. 8E, it may be desirable to display a visual representation of the user that is jumping and not seated. Thus, the animation may be such that the visual representation moves to correspond to the gesture or the desired motion.

In an example embodiment, the system captures the motion intended for remapping and generates a skeletal model of the user, such as that shown in FIG. 5A, to track the motions for remapping gestures. FIGS. 9A-9E each show a frame of image data that corresponds to the snapshots of the user's 602 motion from FIGS. 8A-8E. While the depth camera 608 captures a series of still images, such that in any one image the user appears to be stationary, the user is moving in the course of performing this gesture (as opposed to a stationary gesture, as discussed supra). The system is able to take this series of poses in each still image, and from that determine the moving gesture that the user is making. The image data is parsed to produce a skeletal map 900 of the user 602. The system, having produced a skeletal map 900 from the depth image of the user 602, may also determine how that user's 602 body moves over time, and from that, parse the gesture. The system may apply parameters of the motions to remap the various gestures and redefine the filters for the remapped gestures to correspond to the varied motion.

For example, in FIG. 9A, the user's 602 shoulders 910, elbows 906 and hands 902 are recognized as being held at a uniform level in FIG. 8A. This motion is used to define the stagnant pose gesture in the skiing game. The system then detects in FIG. 8B that the right hand 902a lowers as the left hand 902b is raised, with the shoulders 910, elbows 906, and hands 902 staying in a relatively consistent line with respect to each other. This skiing gesture, comprising leaning and moving down the hill, is remapped to the user's 602 motion in FIG. 8B. In FIG. 8C, the system detects that the hands 902 are raised above the user's head 922 and are above the elbows 906, which are above the shoulders 910, and remaps this to the jumping straight up gesture. In FIG. 8D, the user 602 has returned to the position of FIG. 8A, where the shoulders 910, elbows 906 and hands 902 are at a uniform level, similar to the stagnant pose gesture of FIG. 8A. The scissor kick gesture, shown in FIG. 8E, may be remapped to user's 602 motion that comprises returning to the position of FIG. 8C that represents a jumping gesture, where the hands 902 are raised above the user's head 922 and are above the elbows 906, which are above the shoulders 910. However, in FIG. 8E, the user's upper body is also turned to the left and the user's right hand 902a, elbow 906a, and shoulder 910a are pointed towards the front and the user's left hand 902b, elbow 906b, and shoulder 910b are pointed towards the back. Thus, the corresponding jumping gesture, to be identified as a scissor kick gesture, may comprise the additional upper body movements.

In performing the gesture, the application using the gesture filters that have been remapped for the remapped gesture for the skiing gestures may also tune the associated parameters to best serve the specifics of the application. For instance, the position in FIGS. 8C may be recognized any time the user has his hands 902 above his shoulders 910, without regard to the user's lower body position. Additionally, the parameters for a gesture, such as a ski direction gesture, may require that the user move from the position of FIG. 8A to the position of FIG. 8B within a specified period of time, such as 1 second, and if the user takes more than 1.5 seconds to move through these positions, it will not be recognized as an intention for choosing a ski direction.

Gestures may be complementary with each other, and they may be grouped into gesture packages. These gesture packages are then provided to applications for use by a gesture recognizer engine, as described above. An application may utilize one or more gesture packages. A gesture package may include gestures that are packaged as remapped gestures or a gesture package may include options for remapping standard gestures to new data. Thus, the remapped gesture may be provided with the gesture package or the user may have the option to remap a standard gesture.

An application may assign a value to a first parameter of a standard or remapped gesture. The recognizer engine sets the first parameter with the value, and can also set or remap the value of any other parameters of that gesture or any other gestures in the gesture package that are dependent upon the value of the first gesture.

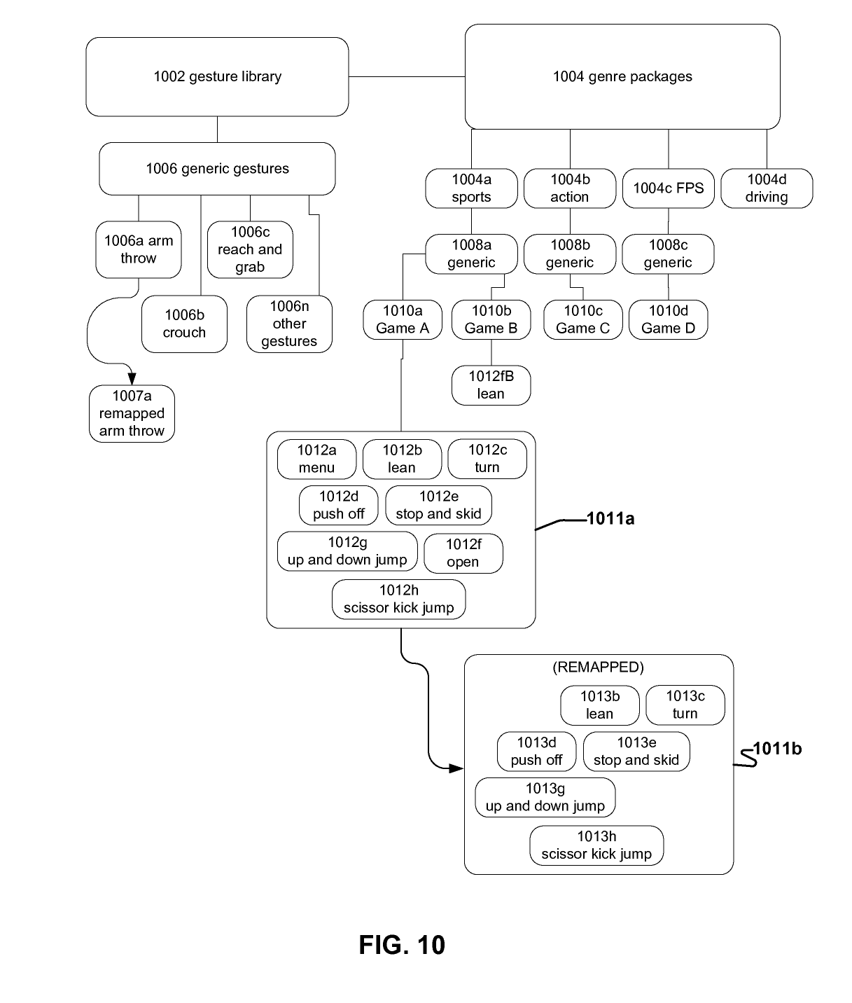

FIG. 10 depicts how generic gesture filters 1006 from a gesture filter library 1002 may be grouped into genre packages 1004 of complementary gesture filters for a particular task. The gesture filter library 1002 may aggregate all gesture filters 1006 provided by the system. In an embodiment, an application may provide additional gesture filters for that application's use. Generic gesture filters comprise things such as “arm throw” 1006a and “crouch down” 1006b. These gesture filters are then grouped together in genre packages 1004.

A genre package 1004 may include those gestures that are commonly used within a genre. A genre package is not limited to groups of complementary gesture filters that work for known genres or applications. A genre package may comprise gesture filters that comprise a subset of those filters used by an application or genre, or filters that are complementary, though an appropriate genre for them has yet to be identified. For instance, a first-person shooter (FPS) genre package 1004c may have gesture filters for shooting a weapon, throwing a projectile, punching, opening a door, crouching, jumping, running, and turning. This FPS genre package 1004c may be thought of as providing a generic FPS genre package 1008c—one with gesture filter parameters tuned or set so that they will likely work acceptably with a large number of FPS applications. Another example is the sports genre package 1004a that provides a generic set of gestures 1008a to Game A 1010a and Game B 1010b. Similarly, the action genre package 1004b provides a generic set of gestures 1008b to Game C 1010c.

An application, such as Game A 1010a or Game B 1010b, may then tune those generic genre packages to meet the particulars of that application or comprise gestures specific to the application that are in addition to the gestures provided in the genre package. The application may tune a generic genre package by setting values for parameters of filters in the genre package. For instance, the creators of Game A 1010a may decide that their game functions best when a demonstrative movement is required to register the lean filter 1012b, because otherwise it is too similar to the turn gesture 1012c. However, the creators of Game B may decide that this is not a concern, and require only a more modest movement to register the lean filter 1012b. Further, the package of gestures 101 la applicable to Game A may comprise both gestures from the generic package 1008a applicable for sports applications and also gestures that may be specific to the skiing game application.

Gestures may be remapped anywhere in the hierarchy shown in FIG. 10. Any of the gestures in the gesture library 1002 or that are part of the genre packages 1004 may be remapped. For example, an arm throw gesture 1006a may be remapped in the generic gestures filter 1006. Anytime the arm throw gesture 1006a is implemented in the system and/or a specific application, for example, the remapped arm throw gesture 1007a may apply. Alternately, the 1006a arm throw gesture filter could be modified to remapped values. Similarly, gestures applicable to a game, such as Game A, may be remapped specifically for that application. For example, Game A 1010a may be the skiing game application described above with respect to FIGS. 7-9. Certain gestures may be remapped either by the system or as selected by the user and be available to Game A. The remapped gestures 1011b represent the gestures applicable to Game A, 1010a, that are remapped to different motion. For example, the up and down jumping gesture 1012g in Game A 1010a may be remapped to use only the upper body, as shown in FIG. 8C. The scissor kickjumping gesture 1012i in Game A may be remapped to the motion represented by FIG. 8E.

The remapped gestures 1011b may be available to the specific user for future use in Game A or any other application. The remapped gestures 1011b may be globally available such that they apply system-wide and/or accessible by other users. Access by other users may be desirable when the remapped gestures 1011b are remapping based on a common feature required to register the standard gesture. For example, in this example, some of the standard gestures 1011a may require movement of the user's lower body. The remapped gestures 1011b may remap the gestures 1011a that require lower body movement and remap them to alternate motions. Any user that wishes to limit lower body movement, therefore, could benefit from the remapped gestures 1011b.

In the embodiment where a genre package comprises machine-readable instructions, a genre package may be provided as those instructions in source code form, or in a form reflecting some amount of compilation of those instructions.

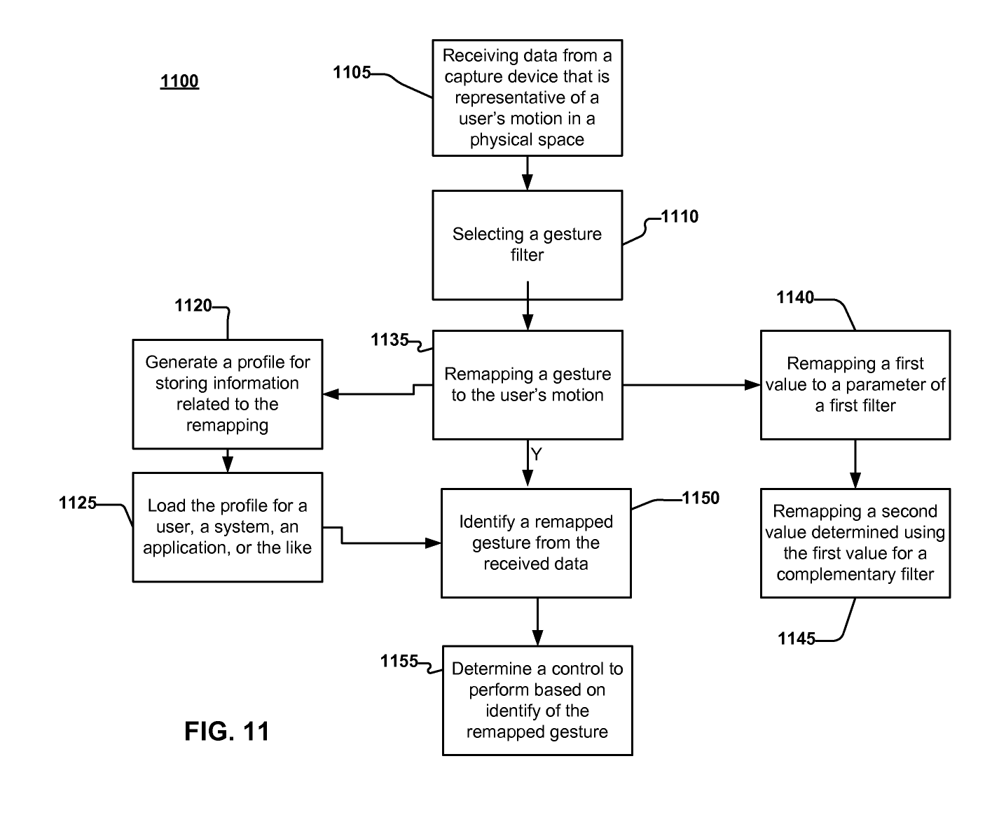

FIG. 11 depicts a flow diagram for a method of remapping a standard gesture. At 1105, a system, such as the tracking system described herein, may receive data from a capture device that is representative of a user's motion in the physical space. For example, the system may receive image data and capture motion with respect to any target in the scene. A gesture recognizer engine, the architecture of which is described more fully below, may be used to determine when a particular gesture has been made by a target, such as a user. The system may include a monitor for visually representing the target.

In some cases, the system will not recognize a gesture from the received data. For example, a user's motion may not correspond to any gesture filters applicable to the system or a particular application. It is possible that the user is incapable of performing the proper motion. It may be desirable to remap certain gestures to different motion. Remapping certain gestures provides a way for users that cannot perform or have difficulty performing certain motions to have success in a gesture-based system where they would otherwise fail.

The remapping of a gesture to the user's motion, at 1115, may be employed by various methods for remapping, as described above. For example, a gesture package may include gestures that are packaged as remapped gestures or a gesture package may include options for remapping standard gestures to new data. Thus, the remapped gesture may be provided with the gesture package or the user may have the option to remap a standard gesture. The application itself may track a user's motion and select to remap a gesture to correspond to the user's motion.

A user may remap motion to particular gestures to initialize the system and/or application with the redefined gestures. The application may recognize a user's repeated motion for a gesture and select to remap the gesture based on history data. For example, an application may track history data of the user and recognize the variations of the user's motion from the motion required to achieve a certain gesture. Certain gesture may be expected at a certain point in an application, such as a baseball pitch when at the point of a user pitching to the hitter. The user may always have some varied motion, such as very limited use of the lower body, and the application may recognize this from history data. The system may remap the gesture and the next time the user performs the motion, with limited lower body movement, the motion may be recognized as the gesture as it was remapped.

The application may recognize a call for remapping by identifying the user's repeated failure to perform a particular gesture. It may be desirable to remap the gesture to make the user's movement a success. The failure may be recognized during the training of a standard gesture. For example, some systems and/or applications provide training sessions or modes to teach a user how to motion properly for a gesture to be recognized. During the training session, the system and/or application may detect a continuous variation in the user's motion that causes a failure (i.e., prevents gesture recognition). The application may ask the user if the user would like to remap a control to the gesture being made by the user.

Consider a bowling game with gestures. When the user performs the gestures they might continually pull up or angle, etc. The gesture could result in a failed swing. The application may provide instructional gesture data in attempts to teach or train the user to perform the correct motion to correspond to the swing motion. However, after several failed attempts to perform the recognizable motion, the game may recognize that the user is not going to correctly perform the gesture. In an effort to decrease player frustration, the game can review the moves the user is making and then map them to a “successful swing gesture. This will help a novice or a user with a physical or mental limitation to be able to be successful in the game.

In another example, the remapped package may be distributed with the application or gesture-based system. For example, a standard set of gestures may be distribute with the application. But, the application may include a package of gestures that are the standard gestures remapped for simpler motion for a novice player. The user may select a remapped package of gestures to execute with the system or an application. For example, a user may select a package of gestures that don't use the upper body or don't require significant motion. A parent, for example, may have a child with autism. The parent may select a package of gestures for execution with an application that are remapped specifically for that characteristic, or a package that is remapped for purposes similar to that characteristic or that would more likely apply to the particular child's capabilities. For example, packages of remapped gestures may be provided that are tailored to less common user characteristics, where the standard gestures are designed for an average player.

During remapping, the system may suggest alternatives to a user for motion to use for remapping a particular gesture. For example, the system may evaluate the standard gestures that are not remapped or the already remapped gestures. The system may provide suggestions for different motions that vary from currently assigned gestures. Thus, the intelligent system can identify conflicts of motion selected for remapping a gesture to avoid confusion by the user and/or within the application.

Also during remapping, the system may identify gestures that are similar to or complimentary to the gesture that is remapped. For example, with respect to the up and down jumping gesture shown in FIG. 7C and the scissor kick jumping gesture shown in FIG. 7E, if the user selects to remap one jumping gesture, the system may identify other jumping gestures that may be similarly remapped. In another example, the user may not have mobility of the right arm. The system may run a filter through the set of standard gestures and identify all of the related gestures that utilize the user's right arm. The system may offer an option to the user to remap the related gestures, or the system may simply make modifications to remap the related gestures based on the gesture selected for remapping.

Training may be provided to a user to learn the motions for the remapped gestures. If the system remaps the gestures or even if the user selects to remap gestures, training sessions may be provided that teach or re-teach the user the motions that correspond to the remapped gesture. The training session may simply be a recording of the user's own motions to exemplify the motions that correspond to a particular gesture.

Using a system as described herein, the user's motions in the physical space may be mapped to the motion of a visual representation of the user on a display. For example, the standard jumping gesture may comprise a user's upper and lower body, and the user's motion may closely resemble a desired display for a jumping gesture. Thus, the system may identify the jumping gesture to control the application, but still use the user's actual motion to map to the screen for visual representation. In the case of remapped motion, the motion that corresponds to a particular gesture may largely vary from the motion that would intuitively correspond to the gesture. For example, jumping gesture may be remapped to utilize only the user's upper body. Thus, in certain circumstances, pre-canned animations may be implemented for the display of a user with respect to a remapped gestures, even if the display for a corresponding standard gesture would map directly to the user's motion.

Although the above examples are described with respect to gaming applications, the same principles may apply in the non-gaming context. Any systems that use gestures for control, such as a computing system that uses gestures to navigate through the computer interface, or an entertainment system that uses gestures to select a movie to watch, the standard gesture that defines the control may not be one that a user can perform. For example, if the gesture to select a tab on a computer interface comprises an arm sweep using the right arm, and the user doesn't have mobility for that arm, the user may wish to remap the gesture.

The virtual space may comprise a representation of some part of the user's physical space. A depth camera that is capturing the user may also capture the environment that the user is physically in, parse it to determine the boundaries of the space visible by the camera as well as discrete objects in that space, and create virtual representations of all or part of that, which are then presented to the user as a virtual space. Thus, it is contemplated that other aspects of the display may represent objects or other users in the physical space. For example, the audience shown on the screen 612 in FIG. 6 may represent at least one or more users in the background of the physical space, where the animation of the audience member on the screen 612 may map to the motions of a background user in the physical space.

In an embodiment, the virtual object corresponds to a physical object. The depth camera may capture and scan a physical object and display a virtual object that maps directly to the image data of the physical object scanned by the depth camera. This may be a physical object in the possession of the user. For instance, if the user has a ball, that physical ball may be captured by a depth camera and a representation of the ball may be inserted into the virtual environment. Where the user moves the physical ball, the depth camera may capture this, and display a corresponding movement of the virtual ball.

A gesture may comprise the recognition of a user's motions including how the user interacts with an object in the physical space. For example, a basketball bouncing gesture may be recognized by identifying the user's motions and a ball the user interacts with by bouncing. Similar to remapping gestures to correspond to different motions made by the user, a gesture that involves the recognition of a physical object as part of the motion may be remapped. Again, using the example of a user with limited lower body mobility, the user may remap a bouncing gesture. Perhaps the straightforward bouncing gesture could still be mapped to the user's bouncing of the ball. But consider a bouncing-through-the-legs gesture that comprises the user separating his or her legs, and bouncing the basketball through the user's separated legs. The user, with limited lower body mobility, may remap the gesture to comprise a different motion or a motion along with a vocal command. For example, the user may cross the ball across the user's seated position and switch the hand that bounces the ball, at the same time saying “through the legs.”

The remapping techniques may be available in certain systems or application to allow alternative gestures to enable novice users or to support users with physical or mental limitations who could not otherwise perform the required gesture input. Allowing for the flexibility in the motion required to be recognized for a particular gesture provides for a positive user experience and may add to the experience for family play or single player success, especially where the goal is having fun. The remapping techniques enable all sorts of different types of players to achieve success in a game, for example. For applications where success/failure may not be important, such as simply an application that tells a story with user interaction and mapping user motions to the screen, it may be more pleasing that the user can navigate through the story without failing to meet strict gesture requirements.

Remapping gestures may be an optional solution for a system or application. Alternately, some systems or applications may not provide an option that supports alternative inputs as it is against the “goal” of the game. For example, allowing for remapping may not be suited for competitive games. Thus, some programs may choose not to have this feature, some programs may provide it as an option, and some may provide it as an option for only certain skill levels, leaving it up to the user to take on a challenge of more complex motions. Further, in a single game, only some modes of the game might support remapping and other modes may not support remapping. For example, a family play mode may support remapping but live play or competitive play modes may not support remapping.

The remapped gestures may become part of a profile, such as the profile 198 shown in FIG. 2. For example, the system may generate the profile for storing information related to the remapped gestures at 1120 which may be loaded for future user at 1125. The profile may be specific to a specific user, for example. A profile may be accessed upon entry of a user into a capture scene. The profile may be program-specific, or be accessible globally, such as a system-wide profile. For example, a remapped gesture may be implemented system-wide for a commonly performed gesture such that the user does not have to remap the gesture for each instance or in each environment for which it may be used. Consider a “open file” gesture that may be common in many applications. If the gesture comprises motion of the user's arms, and the user does not have full use of both arms, the gesture may be remapped to a motion that the user can perform. The user's profile can be loaded for future use and it can be loaded for use by other users.

If a profile matches a user based on a password, selection by the user, body size, voice recognition or the like, then the profile may be loaded. If there is a match, the gestures that the user has remapped may be implemented and/or the system may develop remapped gestures based on the user's profile data.

History data for a user may be monitored, storing information to the user's profile. The system may remap gestures to correspond to the history data. For example, applications, such as dashboards, a game, a computer UI, can monitor and track a user's success at performing a specific movement or gesture applicable to the application. Instead of continually indicating to the users that they are FAILING to perform a specific movement or gesture, the program can identify what movement the user is making and remap that input to the correct action. The application can then save that information within the program or globally as part of the user's profile to be used by other programs. As described above, the user's history data that pertains to an expected gesture may be tracked, and the system may remap a standard gesture to correspond to the history data of the user's motions.

The method also illustrates exemplary operational procedures for tuning complementary gesture filters in a filter package when a gesture is remapped based on at least one parameter of one filter. At 1140, for example, remapping a gesture to the user's motion may comprise remapping a first value of a parameter of a first gesture filter. The application or system may comprise a package with a plurality of filters, each filter comprising information about a gesture and at least one parameter, each filter being complementary with at least one other filter in the package. The package may represent gesture filters for a particular genre. For example, genre packages for video games may include genres such as first-person shooter, action, driving, and sports.

As used herein, and in at least one embodiment, “providing a package” may refer to allowing access to a programming language library file that corresponds to the filters in the package or allowing access to an application programming interface (API) to an application. The developer of the application may load the library file and then make method calls as appropriate. For instance, with a sports package there may be a corresponding sports package library file.

When included in the application, the application may then make calls that use the sports package according to the given API. Such API calls may include returning the value of a parameter for a filter, setting the value of a parameter for a filter, and correlating identification of a filter with triggering some part of the application, such as causing a user controlled tennis player to swing a tennis racket when the user makes the appropriate tennis racket swing gesture.

As described above, a gesture may comprise a wide variety of things. It may, for instance, be any of a crouch, a jump, a lean, an arm throw, a toss, a swing, a dodge, a kick, and a block. Likewise, a gesture may correspond to navigation of a user interface. For instance, a user may hold his hand with the fingers pointing up and the palm facing the 3D camera. He may then close his fingers towards the palm to make a first, and this could be a gesture that indicates that the focused window in a window-based user-interface computing environment should be closed.

As gestures may be used to indicate anything from that an avatar in an application should throw a punch to that a window in an application should be closed, a wide variety of applications, from video games to text editors may utilize gestures.

As described herein, standard gestures, such as those provided with an application, may be remapped. For example, at 1135, a user or a system may opt to remap a gesture to different motion. The remapping may be based on actual capture motion, or the remapping may be based on parameters set by the system or application.

Complementary gesture filters—either complementary as in those that are commonly used together, or complementary as in a change in a parameter of one will change a parameter of another—may be grouped together into genre packages that are likely to be used by an application in that genre. These packages may be available or identified to an application, which may select at least one. The application may remap a gesture that modifies at least one parameter of the standard gesture such that a second, complementary parameter (in the inter-dependent sense) of either the filter or a second filter may also be remapped such that the parameters remain complementary.

An application-determined parameter may comprise any of a wide variety of characteristics of a filter, such as a body part, a volume of space, a velocity, a direction of movement, an angle, and a place where a movement occurs. The disclosed remapping techniques may alter the application-determined parameter. Alternately, the application-determined parameter may be a remapped parameter based on the history data or user profile for a particular user.

In an embodiment, the value of the remapped parameter is determined by an end user of the application through making a gesture. For instance, an application may allow the user to train it, so that the user is able to specify what motions he believes a gesture should comprise. This may be beneficial to allow a user without good control over his motor skills to be able to link what motions he can make with a corresponding gesture. If this were not available, the user may become frustrated because he is unable to make his body move in the manner required by the application to produce the gesture.

In an embodiment where there exist complementary filters—a plurality of filters that have inter-related parameters—receiving from the application a value for an application-determined parameter of the first filter may include both setting the application-determined parameter of the first filter with the value, and setting a complementary application-determined parameter of a second, complementary filter based on the value of the parameter of the first filter. For example, one may decide that a user who throws a football in a certain manner is likely to also throw a baseball in a certain manner. So, where it is determined that a certain application-determined parameter of one filter, such as a velocity parameter on a filter for a football throw gesture, should be set in a particular manner, other complementary application-determined parameters, such as the velocity parameter on a baseball throw gesture, may be set based on how that first application-determined parameter is set.

This need not be the same value for a given application-determined parameter, or even the same type of application-determined parameter across filters. For instance, it could be that when a football throw must be made with a forward arm velocity of X m/s, then a football catch must be made with the hands at least distance Y m away from the torso.

The value may be a threshold, such as arm velocity is greater than X. It may be an absolute, such as arm velocity equals X. There may be a fault tolerance, such as arm velocity equals within Y of X. It may also comprise a range, such as arm velocity is greater than or equal to X, but less than Z.

The remapping at 1140 may comprise the re-assignment of a value to the parameter of the first filter. Where an association between parameters and their values is stored in a database, this may comprise storing the value in the database along with an association with the parameter.

At 1145, the method comprises remapping a second value to a second parameter of a second filter, the second value determined using the value assigned to the parameter of the first filter. As discussed above, the second value may relate to the first value in a variety of ways. Where the two parameters involve something substantially similar such as a threshold jump height, the second value may be equal to the first value. The second value and the first value may have a variety of other relationships, such as a proportional relationship, an inversely proportional relationship, a linear relationship, an exponential relationship, and a function that takes the value as an input.

In an embodiment where filters may inherit characteristics from each other, such as in an object-oriented implementation, the second filter may comprise a child of the first filter, with the first filter likewise being a parent to the second filter. Take for example, a “hand slap” filter. This filter may serve as a parent to variations on hand slaps, such as the “high five,” the “high ten” and the “low five.” Where the “hand slap” has a “hand movement distance threshold” parameter, when the value to that parameter is set, the “hand movement distance threshold” parameter for all child filters may be set with that same value.

Likewise, the complementary nature of two parameters may be due to one filter being stacked to be incorporated into another filter. One filter may be a steering filter, and that is stacked with other filters such as gear shift, accelerate and decelerate to create a driving filter. As the “minimum steering angle threshold” parameter of the steering filter is modified, the corresponding “minimum steering angle threshold” parameter of the driving filter may also be modified.

Where an application selects a filter package for use, such as by including a library file for that filter package, it likely does so because those filters are to be frequently used by a user of the application. Further, filters in a filter package may be used in close succession, such as with run, jump, strafe, crouch and discharge firearm filters in a first-person shooter package. To this end, where a filter package has been identified as being used by an application, a system processing filters, such as the base filter engine described above, can likely reduce the processing resources required to process image data corresponding to user input by first processing the data for those filters comprising the selected filter package.

At 1150, the system may receive data representative of a user's motion and recognize a remapped gesture from the data. The computing environment may determine which controls to perform at 1155, such as the control of an application executing on the computer environment, that corresponds to the remapped gestures. A visual representation of the user may be displayed, such as via an avatar on a screen, that maps to the user's motions, and the user may control aspects of the application by gesturing in the physical space.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Furthermore, while the present disclosure has been described in connection with the particular aspects, as illustrated in the various figures, it is understood that other similar aspects may be used or modifications and additions may be made to the described aspects for performing the same function of the present disclosure without deviating therefrom. The subject matter of the present disclosure includes all novel and non-obvious combinations and sub-combinations of the various processes, systems and configurations, and other features, functions, acts, and/or properties disclosed herein, as well as any and all equivalents thereof. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments.

In addition to the specific implementations explicitly set forth herein, other aspects and implementations will be apparent to those skilled in the art from consideration of the specification disclosed herein. Therefore, the present disclosure should not be limited to any single aspect, but rather construed in breadth and scope in accordance with the appended claims. For example, the various procedures described herein may be implemented with hardware or software, or a combination of both.

What is claimed:

1. A method for remapping a gesture, the method comprising:
selecting a gesture filter that corresponds to the gesture for remapping;
receiving data from a capture device that is representative of a user's motion in a physical space; and
remapping the gesture to the user's motion, wherein remapping the gesture comprises modifying the gesture filter to correspond to the received data.

2. The method of claim 1, wherein the gesture filter comprises base information about the gesture, and remapping the gesture to the user's motion comprises modifying the base information to correspond to the received data.

3. The method of claim 2, further comprising assigning permissible tolerances for recognizing the gesture to the modified base information.

4. The method of claim 1, further comprising identifying an intended control based on the data received from the capture device, wherein selecting the gesture filter comprises selecting the gesture filter that corresponds to a gesture for the intended control.

5. The method of claim 1, further comprising collecting a history of data representative of the user's motion the physical space, wherein remapping the gesture to the user's motion comprises remapping the gesture to correspond to the history data representative of the user's motion.

6. The method of claim 5, further comprising detecting a repeated variation between the history of data representative of the user's motion in the physical space and requirements of a gesture filter for an expected gesture, wherein the gesture for remapping is the expected gesture.

7. The method of claim 1, further comprising generating a profile with information about the remapped gesture, wherein the profile can be loaded for at least one of system-wide use, application use, a user associated to the profile, or a user that is not associated with the profile.

8. The method of claim 1, further comprising receiving a request to remap the gesture, wherein the gesture filter is selected that corresponds to the request.

9. The method of claim 1, further comprising determining if the received data is representative of a remapped gesture.

10. The method of claim 9, wherein determining if received data is representative of a remapped gesture comprises receiving data reflecting skeletal movement of a user, and comparing the data to the gesture filter that corresponds to the remapped gesture.

11. The method of claim 9, further comprising displaying a visual representation of the user that maps to the user's motion, and animating at least a portion of the visual representation to correspond to the remapped gesture.

12. The method of claim 1, wherein modifying the gesture filter comprises modifying a parameter of the gesture filter that represents a body part, a volume of space, a velocity, a direction of movement, an angle, a two-dimensional (2D) plane, or a place where a movement occurs.

13. A system for remapping a gesture, the system comprising:
a capture device, wherein the capture device receives data that is representative of a user's motion in a physical space; and
a processor, wherein the processor executes computer executable instructions, and wherein the computer executable instructions comprise instructions for:
selecting a gesture filter that corresponds to the gesture for remapping; and
remapping the gesture to the user's motion, wherein remapping the gesture comprises modifying the gesture filter to correspond to the received data.

14. The system of claim 13, wherein the gesture filter comprises base information about the gesture, and remapping the gesture to the user's motion comprises modifying the base information to correspond to the received data.

15. The system of claim 14, further comprising assigning permissible tolerances to the modified base information.

16. The system of claim 13, further comprising identifying an intended control based on the data received from the capture device, wherein selecting the gesture filter comprises selecting the gesture filter that corresponds to a gesture for the intended control.

17. The system of claim 13, further comprising collecting a history of data representative of the user's motion the physical space, wherein remapping the gesture to the user's motion comprises remapping the gesture to correspond to the history data representative of the user's motion.

18. The system of claim 17, further comprising detecting a repeated variation between the history of data representative of the user's motion in the physical space and requirements of a gesture filter for an expected gesture, wherein the gesture for remapping is the expected gesture.

19. The system of claim 13, further comprising generating a profile with information about the remapped gesture, wherein the system is configured to load the profile for at least one of system-wide use, application use, a user associated with the profile, or a user that is not associated with the profile.

20. The system of claim 13, further comprising a display device for displaying a visual representation of the user that maps to the user's motion, wherein at least a portion of the visual representation is animated to correspond to the remapped gesture.

21. The system of claim 13, further comprising receiving a request to remap the gesture, wherein the gesture filter is selected that corresponds to the request.

22. A method for remapping a package of complementary gesture filters, the method comprising:
providing a package comprising a plurality of filters, each filter comprising information about a gesture, at least one filter being complementary with at least one other filter in the package;
remapping a first value to a first parameter of a first filter to correspond to data received from a capture device that is representative of a user's motion in a physical space;
remapping a second value to a second parameter of a second filter, the second value determined using the first value.

23. The method of claim 22, wherein a recognizer engine sets the first parameter for a first gesture with the first value, and remaps a value of any other parameters of that gesture or any other gestures in the package that are dependent upon the first value of the first gesture.

24. The method of claim 22, wherein modifying the gesture filter comprises modifying a parameter of the first filter that represents a body part, a volume of space, a velocity, a direction of movement, an angle, a two-dimensional (2D) plane, or a place where a movement occurs.

25. The method of claim 22, wherein a filter is complementary with the at least one other filter in the package when (i) that filter has at least one parameter that is determined based on a parameter of the at least one other filter in the package, (ii) that filter represents a gesture that is commonly made by a user within a short time period of a gesture represented by the at least one other filter in the package, or (iii) the gesture represented by that filter is capable of being made simultaneously with a gesture represented by the at least one other filter in the package.

26. The method of claim 22, wherein the second value is determined using the first value based on a proportional relationship, an inversely proportional relationship, a linear relationship, an exponential relationship, or a function that takes the first value as an input.
